(19) United States
(12) Patent Application Publication
(10) Pub. No.: US 2026/0257482 A1
(43) Pub. Date: Sep. 3, 2026

(54) LIQUID CONTAINER INCLUDING MAIN BODY DEFINING FIRST STORAGE CHAMBER, VALVE, FIRST PORT, AND SUPPORT MEMBER SUPPORTING THE VALVE

(71) Applicant: BROTHER KOGYO KABUSHIKI KAISHA, Nagoya (JP)

(72) Inventors: Masahiro HAYASHI, Anjo (JP); Fumiya NAKAMURA, Nagoya (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 19/655,183

(22) Filed: Apr. 22, 2026

Related U.S. Application Data
(63) Continuation of application No. PCT/JP2024/038478, filed on Oct. 29, 2024.

(30) Foreign Application Priority Data
Nov. 7, 2023 (JP) 2023-190446

(51) Int. Cl. B41J 2/175

(52) U.S. Cl. CPC B41J 2/17503; B41J 2/17566; B41J 2/17596

(57) ABSTRACT

A liquid container includes a main body; a valve; a first port; and a support member. The main body defines a first storage chamber. The main body has a neck portion defining an accommodation space. The valve is positioned inside the accommodation space. The valve is movable between a closed position and an open position in a movement direction. A center axis of the valve is offset relative to a center axis of the neck portion in an offset direction orthogonal to the movement direction. The valve at the open position and the support member define a fluid flow passage. The fluid flow passage is positioned further in an opposite direction relative to the center axis of the neck portion. The opposite direction is a direction opposite to the offset direction.

### REFERENCE TO RELATED APPLICATIONS

This is a by-pass continuation application of International Application No. PCT/JP2024/038478 filed on October 29, 2024 which claims priority from Japanese Patent Application No. 2023-190446 filed on November 7, 2023. The entire content of the priority application is incorporated herein by reference.

### TECHNICAL FIELD

The present disclosure relates to a liquid container configured to store liquid and a system including the liquid container and a second liquid container to which liquid is replenished from the liquid container.

### BACKGROUND ART

A known liquid supply container configured to store ink in the liquid supply container includes: a container main body; a liquid replenishment nozzle; a valve; and a seal. The container main body is configured to accommodate ink in the container main body. The liquid replenishment nozzle has a cylindrical shape, and is mounted on the distal end of the container main body. The valve is positioned inside the inner space of the liquid replenishment nozzle. The seal has an annular shape, and is at a position where the distal end of the container main body is positioned inside the inner space of the liquid replenishment nozzle. The valve is configured to contact the seal. A liquid replenishment passage and an air discharge passage are defined between the valve and the liquid replenishment nozzle. Since a liquid supply portion of an ink tank is inserted in the inner space of the liquid replenishment nozzle through the seal, the valve is pressed. Accordingly, ink inside the container main body flows into the inside of the ink tank through the liquid replenishment passage, which is in the liquid replenishment nozzle, and an ink supply passage which is inside the liquid supply portion. On the other hand, air inside the ink tank flows into the inside of the container main body through the air discharge passage inside the liquid supply portion and an air discharge passage inside the liquid replenishment nozzle. As described above, since gas-liquid exchange occurs between the liquid supply container and the ink tank, ink is replenished from the liquid supply container to the ink tank.

### SUMMARY

In order to smoothly performs gas-liquid exchange between a liquid supply container and an ink tank, it is conceivable to enlarge a liquid supply passage and an air discharge passage inside a liquid supply nozzle by increasing the size of the liquid supply nozzle. However, it is difficult to increase the size of the liquid supply nozzle in a limited space.

In view of the foregoing, it is an object of the present disclosure to provide a liquid container and a system including the liquid container, in each of which gas-liquid exchange is smoothly performed between the liquid container and a tank without increasing the size of the liquid container.

In order to attain the above and other objects, according to one aspect, the present disclosure provides a liquid container including a main body, a valve, a first port, and a support member. The main body defines a first storage chamber configured to store liquid inside the first storage chamber. The main body has a neck portion defining an accommodation space. The valve is positioned inside the accommodation space. The valve is movable between a closed position and an open position. The first port provides communication between an inside of the accommodation space and an outside of the accommodation space in a movement direction of the valve. The first port is closed when the valve is at the closed position. The first port is open when the valve is at the open position. The support member supports the valve such that the valve is movable between the closed position and the open position. In the liquid container: a center axis of the valve extends in the movement direction; a center axis of the neck portion extends in the movement direction; the center axis of the valve is offset relative to the center axis of the neck portion in an offset direction orthogonal to the movement direction; the valve at the open position and the support member define a fluid flow passage providing communication between the first port and the first storage chamber; the fluid flow passage is positioned further in an opposite direction relative to the center axis of the neck portion, the opposite direction being a direction opposite to the offset direction; and the support member has a protruding portion in contact with the valve in the offset direction.

According to another aspect, the present disclosure also provides a system including the liquid container, a connection port to which the liquid container is connectable, and a tank. The tank has a second storage chamber configured to store liquid supplied from the liquid container connected to the connection port.

According to still another aspect, the present disclosure also provides a system including the liquid container, a connection port to which the liquid container is connectable, and a tank. The tank has a second storage chamber configured to store liquid supplied from the liquid container connected to the connection port. In the system: the neck portion of the liquid container has a first neck portion connected to the first storage chamber, and a second neck portion in which the first port is located; a center axis of the second neck portion extends in the movement direction; a center axis of the first neck portion extends in the movement direction; the center axis of the second neck portion is offset relative to the center axis of the first neck portion in the offset direction orthogonal to the movement direction; the center axis of the valve is offset relative to the center axis of the first neck portion in the offset direction; the tank has an inlet providing communication between an inside of the second storage chamber and an outside of the second storage chamber; the connection port is positioned so as to surround a periphery of the inlet; and the second neck portion is connectable to the connection port.

In the above structures, since the center axis of the valve in the movement direction is offset relative to the neck portion, the valve at the open position and the support member can define the fluid flow passage, which is large and is located in the opposite direction opposite to the offset direction, without increasing the size of the liquid container. Accordingly, air which has flowed into the accommodation space through the first opening is likely to move inside the fluid flow passage, and therefore gas-liquid exchange between the inside of the liquid container and the outside of the liquid container can be smoothly performed. In other words, gas-liquid exchange between the liquid container and a tank can be smoothly performed. As a result, liquid supply speed from the liquid container to the tank to which the liquid container is connected can be improved. Also, the protruding portion in contact with the valve in the offset direction. As a result, the likelihood that the valve is displaced in the opposite direction when the valve moves from the open position to the closed position can be reduced, regardless of the fluid flow passage, which is large and is located in the opposite direction opposite to the offset direction, is located.

In the above structures, gas-liquid exchange can be smoothly performed between the liquid container and the tank without increasing the size of the liquid container.

### BRIEF DESCRIPTION OF DRAWINGS

FIG. 1 is an external perspective view of a multifunctional peripheral.

FIG. 2 is a vertical cross-sectional view schematically illustrating the internal structure of a printer section.

FIG. 3 is a plan view illustrating the arrangement of a carriage and an ink tank.

FIG. 4 is a perspective view of an ink tank set.

FIG. 5 is a perspective view of the ink tank.

FIG. 6 is a vertical cross-sectional view of the ink tank set taken along a plane having an ink chamber.

FIG. 7 is a perspective view of an ink bottle.

FIG. 8 is a schematic view illustrating the external shape of a protrusion.

FIG. 9 is a perspective view of a rubber.

FIG. 10 is another perspective view of the rubber.

FIG. 11 is a perspective view of a support member.

FIG. 12 is another perspective view of the support member.

FIG. 13 is a perspective view of a valve.

FIG. 14 is a vertical cross-sectional view of the ink bottle in a state where the valve is positioned at a closed position.

FIG. 15 is a vertical cross-sectional view of the ink bottle in a state where the valve is positioned at an open position.

FIG. 16 is a vertical cross-sectional view illustrating a state where the ink bottle 80 is attached to the ink tank set.

FIG. 17 is a cross-sectional view illustrating the valve at the open position and the support member taken along a horizontal plane having a portion where the rear inner curved surface of the support member is positioned.

FIG. 18 is an enlarged view of the vicinity of the protrusion illustrated in FIG. 14.

### DESCRIPTION

Hereinafter, an embodiment of the present disclosure will be described. It should be understood that the following embodiment is merely an example of the disclosure, and that this embodiment may be modified as appropriate without departing from the spirit of the disclosure. In the following description, a direction from the starting point to the end point of one of one-headed arrows, which constitute a double-headed arrow, is referred to as an orientation, both directions of the double-headed arrow are collectively referred to as a direction. In other words, the orientation is a component of the direction. Both an upward orientation and a downward orientation are components of an up-down direction and are opposite to each other. Both a leftward orientation and a rightward orientation are components of a left-right direction and are opposite to each other. Both a frontward orientation and a rearward orientation are components of a front-rear direction and are opposite to each other. Also, in this embodiment, the up-down direction corresponds to the direction of gravity and the front-rear direction and left-right direction correspond to the horizontal direction.

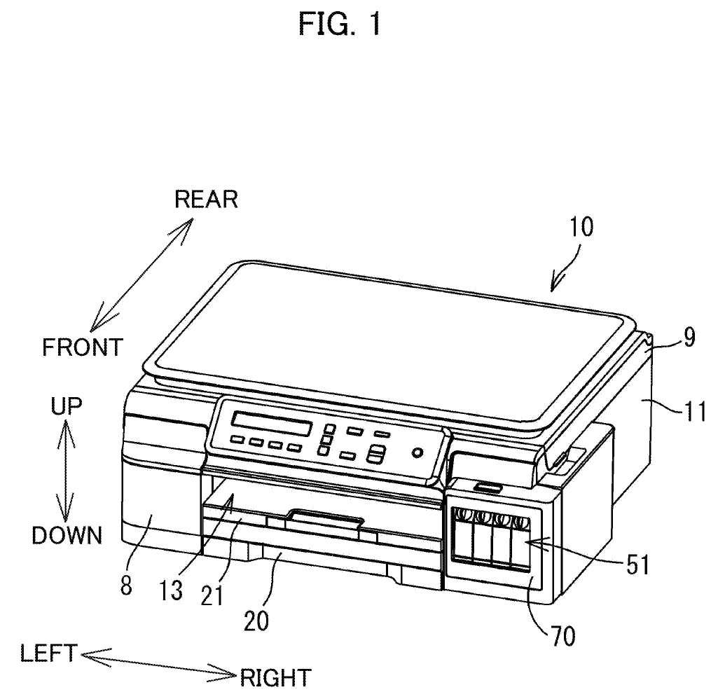

Further, the up-down direction is defined based on a state or an orientation of a multifunction peripheral 10 which is placed and ready for use. The front-rear direction is defined based on the assumption that the portion of the multifunction peripheral 10 in which an opening 13 is disposed is a front portion. The left-right direction is defined based on the perspective of a user viewing the multifunction peripheral 10 from the front portion. The state of the multifunction peripheral 10 shown in FIG. 1 will be sometimes referred to as the “usable state”. The orientation of the multifunction peripheral 10 shown in FIG. 1 will be sometimes referred to as the “usable orientation”. The front surface of the multifunction peripheral 10 is at the front portion of the multifunction peripheral 10, at which the opening 13 is disposed.

Overall Configuration of the Multifunction Peripheral 10

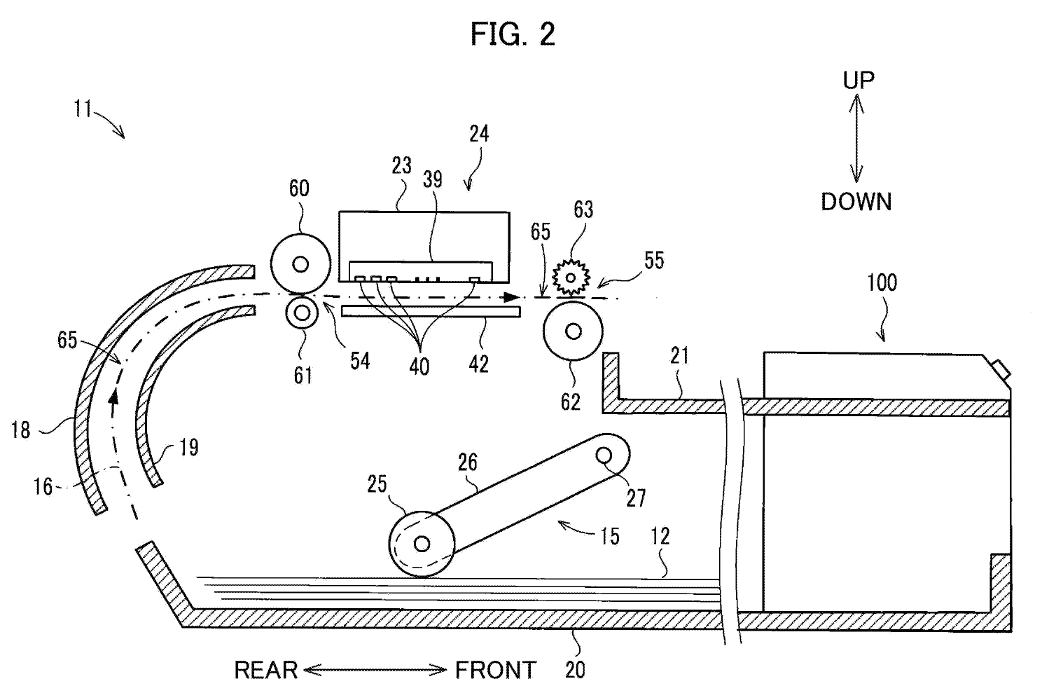

As illustrated in FIG. 1, the multifunction peripheral 10 includes a casing 8 having a generally rectangular-parallelepiped shape. The multifunction peripheral 10 includes a scanning section 9 and a printer section 11 in the inner space of the casing 8. The scanning section 9 is positioned in the upper portion of the inner space of the casing 8. The scanning section 9 has a scanning function. The printer section 11 is positioned below the scanning section 9 in the inner space of the casing 8. The printer section 11 has a printing function. The printer section 11 is configured to record an image on a sheet 12 illustrated in FIG. 2 based on an inkjet recording method. As illustrated in FIGS. 1 and 2, the printer section 11 includes a feeding section 15, a feeding tray 20, a discharging tray 21, a conveying path 65, a conveying roller section 54, a recording section 24, a discharging roller section 55, a platen 42, and an ink tank set 51.

The Feeding Tray 20 and the Discharging Tray 21

As illustrated in FIG. 1, the opening 13 is located at the center in the left-right direction of the front surface of the multifunction peripheral 10. The feeding tray 20 is movable in the front-rear direction through the opening 13 with user’s operation. As illustrated in FIG. 2, the feeding tray 20 is configured to support the sheets 12 stacked on the feeding tray 20. The discharging tray 21 is positioned above the feeding tray 20. The discharging tray 21 is movable with the feeding tray 20 in the front-rear direction. The discharging tray 21 is configured to support the sheets 12 discharged by the discharging roller section 55.

The Feeding Section 15

The feeding section 15 is configured to convey the sheets 12 supported on the feeding tray 20 to the conveying path 65. As illustrated in FIG. 2, the feeding section 15 includes a feeding roller 25, a feeding arm 26, and a shaft 27. The feeding roller 25 is rotatably supported by the feeding arm 26 at the end portion of the feeding arm 26. Since a drive force is transmitted from a conveying motor (illustration is omitted) to the feeding roller 25, the feeding roller 25 is rotated in a direction and therefore the sheet 12 is conveyed in a conveying direction 16. Hereinafter the rotations of the feeding roller 25, a conveying roller 60, and a discharging roller 62 in the direction each of which conveys the sheet 12 in the conveying direction 16 are referred to as a “forward rotation”. The feeding arm 26 is pivotally movably supported by the shaft 27 supported by the frame of the printer section 11. The feeding arm 26 is urged by its own weight or by an elastic force generated with a spring or the like so as to pivotally move toward the feeding tray 20.

The Conveying Path 65

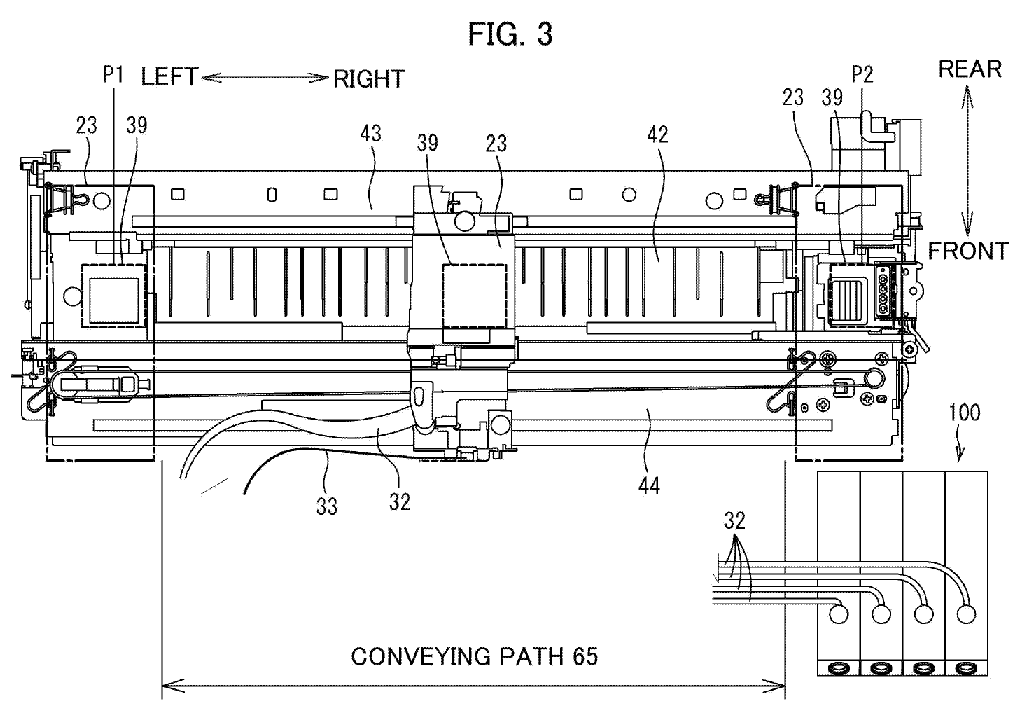

As illustrated in FIG. 2, the conveying path 65 refers to a space which is defined by an outer guide member 18 and an inner guide member 19 facing each other at a predetermined interval, for example. The conveying path 65 extends from the rear end portion of the feeding tray 20 to the rear portion of the printer section 11, and extends from the bottom to the top at the rear portion of the printer section 11 while the conveying path 65 is curved in a U-turn. Then, the conveying path 65 extends to the discharging tray 21 through a space between the recording section 24 and the platen 42. As illustrated in FIGS. 2 and 3, the portion of the conveying path 65 between the conveying roller section 54 and the discharging roller section 55 is located approximately at the center of the multifunction peripheral 10 in the left-right direction, and extends in the front-rear direction. In FIG. 2, the conveying direction 16 of the sheet 12 in the conveying path 65 is indicated with a one-dot chain arrow.

The Conveying Roller Section 54

As illustrated in FIG. 2, the conveying roller section 54 is positioned upstream of the recording section 24 in the conveying direction 16. The conveying roller section 54 includes the conveying roller 60 and a pinch roller 61. The conveying roller 60 and the pinch roller 61 face each other in the up-down direction. Since a drive force of the conveying motor is transmitted to the conveying roller 60, the conveying roller 60 is rotated. The pinch roller 61 is rotated in accordance with the rotation of the conveying roller 60. Since the conveying roller 60 is rotated forward by the forward rotation of the conveying motor, the sheet 12 is nipped between the conveying roller 60 and the pinch roller 61 and is conveyed in the conveying direction 16.

The Discharging Roller Section 55

As illustrated in FIG. 2, the discharging roller section 55 is positioned downstream of the recording section 24 in the conveying direction 16. The discharging roller section 55 includes the discharging roller 62 and a spur 63. The discharging roller 62 and the spur 63 face each other in the up-down direction. Since a drive force of the conveying motor is transmitted to the discharging roller 62, the discharging roller 62 is rotated. The spur 63 is rotated in accordance with the rotation of the discharging roller 62. Since the discharging roller 62 rotates forward by the forward rotation of the conveying motor, the sheet 12 is nipped between the discharging roller 62 and the spur 63, and is conveyed in the conveying direction 16.

The Recording Section 24

As illustrated in FIG. 2, the recording section 24 is positioned between the conveying roller section 54 and the discharging roller section 55 in the conveying direction 16. The recording section 24 faces the platen 42 in the up-down direction. The conveying path 65 is between the recording section 24 and the platen 42 in the up-down direction. The recording section 24 is positioned above the conveying path 65 in the up-down direction. The recording section 24 includes a carriage 23 and a recording head 39.

As illustrated in FIG. 3, the carriage 23 is supported by guide rails 43 and 44. The guide rails 43 and 44 are supported by the frame of the printer section 11. The guide rails 43 and 44 are apart from each other in the front-rear direction. Each of the guide rails 43 and 44 extends in the left-right direction. In the left-right direction, each of the guide rails 43 and 44 extends outward of the conveying path 65. That is, each guide rails 43 and 44 has left end portion and the right end portion which are located outward of the conveying path 65 in the left-right direction. The carriage 23 is mounted to a known belt mechanism disposed at the guide rail 44. Since a drive force is transmitted from a carriage motor (illustration is omitted) to the belt mechanism, the belt mechanism is rotated. Since the belt mechanism is rotated, the carriage 23 moves in the left-right direction. In FIG. 3, the movement range of the carriage 23 is indicated with a one-dot chain line. The carriage 23 is configured to move rightward of the conveying path 65 in the left-right direction and is configured to move leftward of the conveying path 65 in the left-right direction.

An ink tank 100 and the recording head 39 are connected to each other by ink tubes 32. A control board on which a control unit is mounted and the recording head 39 are electrically connected to each other by a flexible flat cable 33. Note that the illustration of the control board is omitted. The ink tubes 32 and the flexible flat cable 33 extend from the carriage 23. The ink tubes 32 are configured to supply ink stored in the ink tank 100 to the recording head 39. The flexible flat cable 33 is configured to transmit control signals output from the control unit to the recording head 39.

As illustrated in FIGS. 2 and 3, the recording head 39 is mounted on the carriage 23. The recording head 39 is movable between a standby position P1 and a maintenance position P2 in the left-right direction by the movement of the carriage 23. The standby position P1 is positioned leftward of the conveying path 65. The left is an example of the opposite side. The maintenance position P2 is positioned rightward of the conveying path 65. Multiple nozzles 40 are positioned at the lower surface of the recording head 39. The recording head 39 is configured to eject ink from the nozzles 40 in the form of minute ink droplets. In a process where the carriage 23 moves, the recording head 39 ejects ink droplets to the sheet 12 supported by the platen 42. Accordingly, an image is recorded on the sheet 12.

The Platen 42

As illustrated in FIGS. 2 and 3, the platen 42 is positioned between the conveying roller section 54 and the discharging roller section 55 in the conveying direction 16. The platen 42 faces the recording section 24 in the up-down direction. The platen 42 is configured to support the sheet 12 conveyed by the conveying roller section 54 from below.

The Ink Tank Set 51

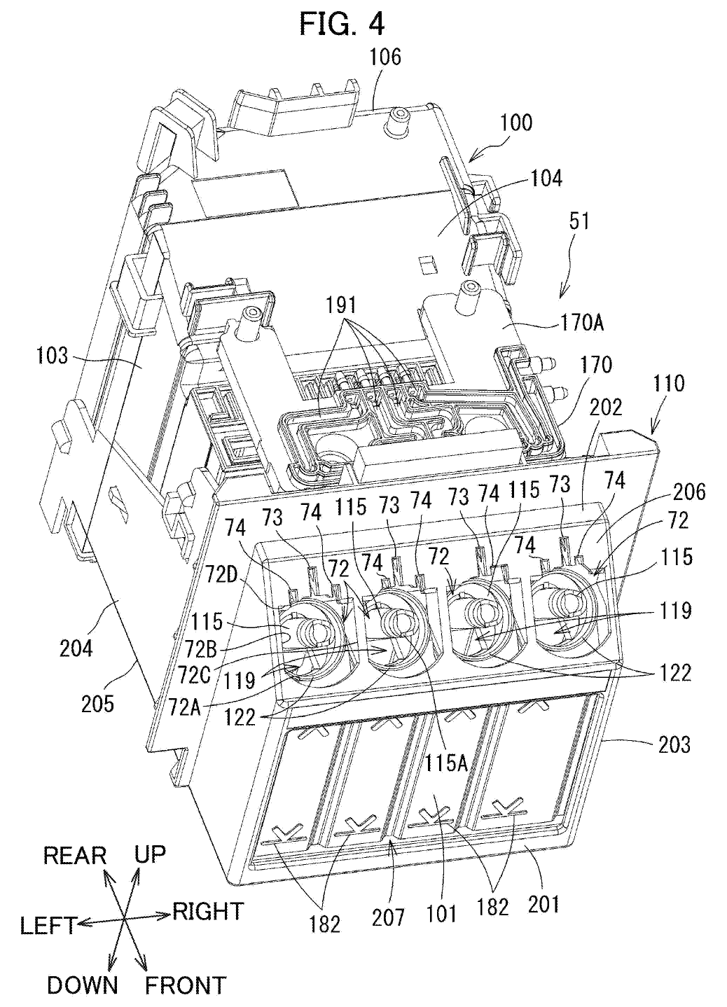

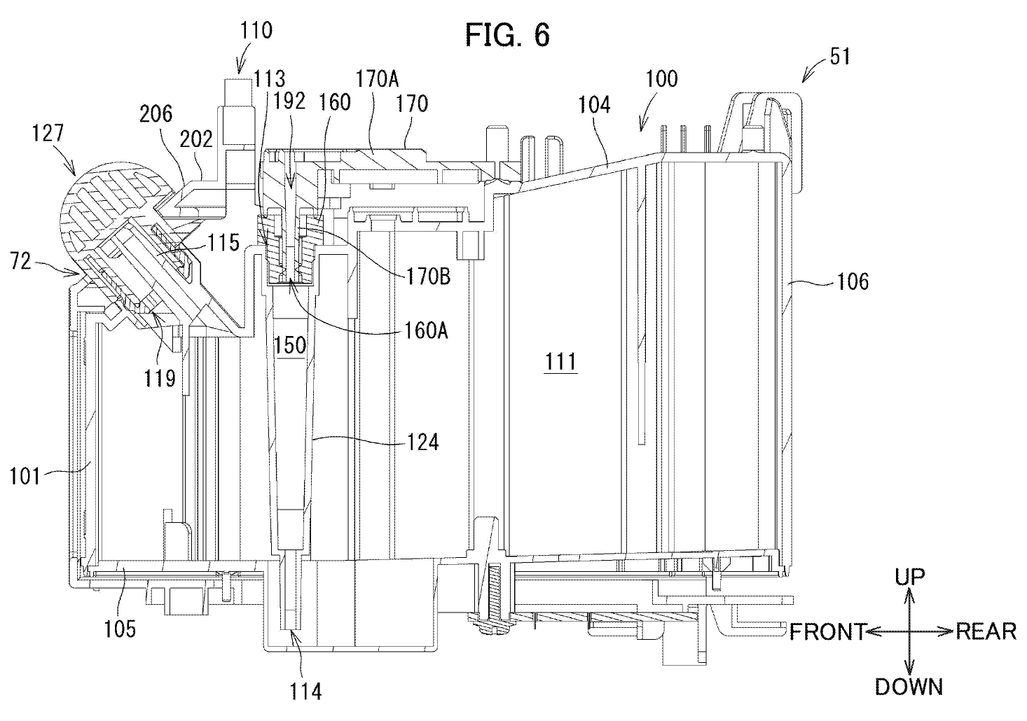

As illustrated in FIGS. 4 and 6, the ink tank set 51 includes the ink tank 100, a tank cover 110, and tank caps 127. The ink tank 100 is an example of the tank. Note that the illustrations of the tank caps 127 are omitted in FIG. 4. As illustrated in FIG. 1, the ink tank set 51 is positioned in the inside of the multifunction peripheral 10. The ink tank set 51 is fixed to the multifunction peripheral 10 such that a user cannot detach the ink tank set 51 easily from the multifunction peripheral 10. In the left-right direction, an opening is positioned at the right end of the front surface of the casing 8 of the multifunction peripheral 10. The ink tank set 51 is positioned rearward of the opening of the casing 8. In other words, in the internal space of the casing 8, the ink tank set 51 is positioned rightward of the center in the left-right direction of the casing 8.

A cover 70 is disposed on the casing 8. The cover 70 is positioned frontward of the opening of the casing 8. The cover 70 is pivotally movable about a pivot shaft. The pivot shaft is positioned at the lower end of the casing 8 in the up-down direction and extends in the left-right direction. The cover 70 is pivotally movable from a covering position illustrated in FIG. 1 to an exposing position. At the covering position, the cover 70 covers the opening of the casing 8. At the exposing position, the opening of the casing 8 is exposed to the outside of the multifunction peripheral 10. In other words, the cover 70 is pivotally movable from the covering position illustrated in FIG. 1, at which the cover 70 covers the ink tank set 51, and the exposing position, at which the ink tank set 51 is exposed to the outside of the multifunction peripheral 10. The cover 70 has an opening. Even when the cover 70 is positioned at the covering position, part of the ink tank set 51 is exposed to the outside of the multifunction peripheral 10 through the opening of the cover 70. Here, “part of the ink tank set 51 is exposed to the outside of the multifunction peripheral 10 through the opening of the cover 70” signifies that a user can see at least part of the ink tank set 51 through the opening of the cover 70 and does not signify that part of the ink tank set 51 protrudes toward the outside of the multifunction peripheral 10 through the opening of the cover 70.

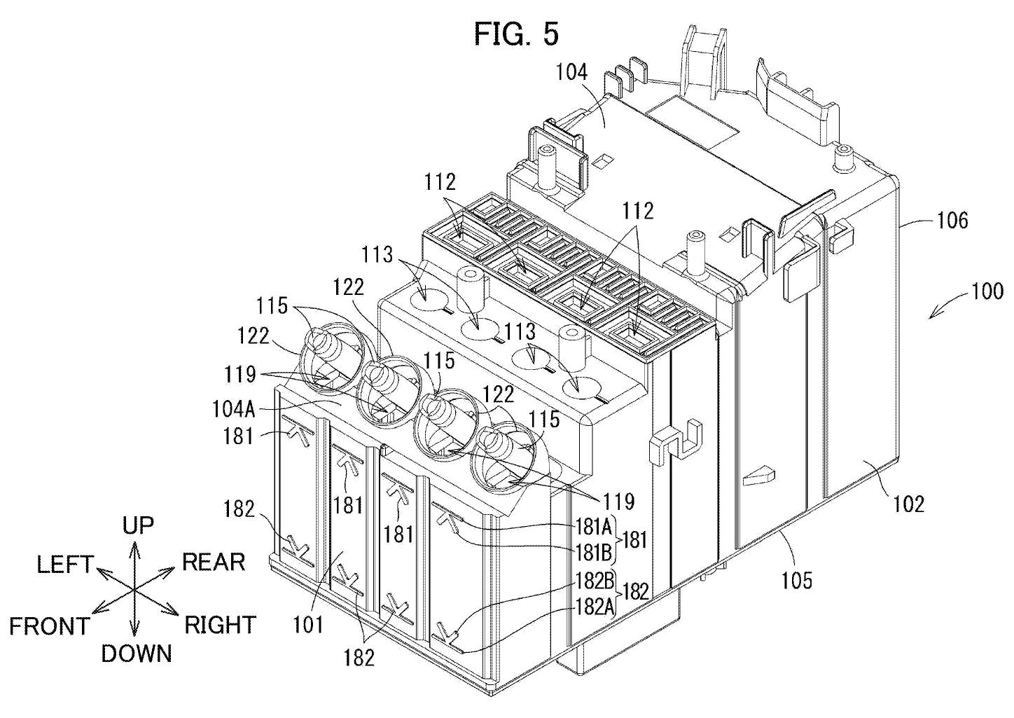

As illustrated in FIGS. 5 and 6, the ink tank 100 includes four ink chambers 111 inside the ink tank 100. The four ink chambers 111 are arranged in the left-right direction. The four ink chambers 111 respectively store yellow ink, cyan ink, magenta ink, and black ink. Ink is an example of the liquid. Each ink chamber 111 is an example of the second storage chamber. For example, ink may be a pigment ink containing a pigment or a dye ink containing a dye. Each ink chamber 111 may store cleaning liquid containing water instead of ink. Cleaning liquid is an example of the liquid.

The ink tank 100 includes a front wall 101, a right wall 102, a left wall 103, an upper wall 104, a lower wall 105, and a rear wall 106. The inner space of the ink tank 100 is partitioned into the four ink chambers 111 by three partition walls arranged in the left-right direction at intervals.

As illustrated in FIG. 5, a front surface 101B of the front wall 101 has four upper marks 181 and four lower marks 182. The four upper marks 181 are arranged in the left-right direction at intervals. The four lower marks 182 are arranged in the left-right direction at intervals. Each upper mark 181 is positioned above the intermediate portion in the up-down direction of the front surface 101B. Each upper mark 181 is positioned at the upper portion of the front surface 101B. Each upper mark 181 is positioned below the upper end of the front surface 101B. Each upper mark 181 includes an upper line 181A and an upper arrow 181B. The upper line 181A extends in the left-right direction. The upper arrow 181B is positioned below the upper line 181A. The top tip of the upper arrow 181B is positioned at the center in the left-right direction of the upper line 181A. The position of each upper mark 181 in the left-right direction corresponds to the corresponding one of the four ink chambers 111. Each upper mark 181 indicates that ink in the corresponding ink chamber 111 has reached a full level when the liquid level of the ink is at the upper line 181A. The upper mark 181 is an example of the mark. The position of the upper line 181A is an example of the full level position.

Each lower mark 182 is positioned below the intermediate portion in the up-down direction of the front surface 101B. Each lower mark 182 is positioned at the lower portion of the front surface 101B. Each lower mark 182 is positioned above the lower end of the front surface 101B. Each lower mark 182 includes a lower line 182A and a lower arrow 182B. The lower line 182A extends in the left-right direction. The lower arrow 182B is positioned above the lower line 182A. The bottom tip of the lower arrow 182B is positioned at the center in the left-right direction of the lower line 182A. The position of each lower mark 182 in the left-right direction corresponds to the corresponding one of the four ink chambers 111. Each lower mark 182 indicates that replenishment of ink into the corresponding ink chamber 111 will soon be required when the liquid level of ink is at the lower line 182A.

The upper wall 104 has air communication ports 112. Each air communication port 112 provides communication between the corresponding ink chamber 111 and the outside of the ink tank 100. The air communication ports 112 extend through the upper wall 104 in the up-down direction. The upper surface of the upper wall 104 has a sloped surface 104A. The sloped surface 104A is positioned at the front end portion of the upper surface of the upper wall 104. The sloped surface 104A is sloped relative to the front-rear direction such that the sloped surface 104A extends downward as the sloped surface 104A extends frontward. The sloped surface 104A extends from the left edge of the ink tank 100 to the right edge of the ink tank 100.

The upper wall 104 has four openings 113. Each opening 113 provides communication between the corresponding ink chamber 111 and the outside of the ink tank 100. The four openings 113 are positioned frontward of the air communication ports 112. The four openings 113 are arranged in the left-right direction at intervals.

As illustrated in FIG. 6, each opening 113 is connected to an outflow tube 124. Each outflow tube 124 is a cylindrical tube extending downward from the corresponding opening 113 in the up-down direction. Each outflow tube 124 has an outflow opening 114 at the lower end of the outflow tube 124. Each outflow opening 114 opens downward.

In each outflow tube 124, a sealing member 160 is press-fitted through the corresponding opening 113. Each sealing member 160 has a through-hole 160A extending in the up-down direction.

As illustrated in FIGS. 4 and 6, each outflow tube 124 is connected to a connecting portion 170 disposed on the upper surface of the upper wall 104. The connecting portion 170 has a board 170A and four cylindrical portions 170B. The board 170A has a flat shape. The board 170A is mounted to the upper wall 104 such that the board 170A is attachable to and detachable from the upper wall 104. Each cylindrical portion 170B has a cylindrical shape and extends downward from the board 170A in the up-down direction. Four grooves through which ink can flow are positioned on the upper surface of the board 170A. The board 170A has four first ink flow passages 191. The first ink flow passages 191 are defined by the four grooves and a film affixed to the upper surface of the board 170A. Note that the illustration of the film is omitted in FIGS. 4 and 6. Each first ink flow passage 191 is connected to the corresponding one of the ink tubes 32, connected to the recording head 39. Each cylindrical portion 170B has a second ink flow passage 192 through which ink can flow. Each second ink flow passage 192 is in communication with the corresponding one of the first ink flow passages 191. Each cylindrical portion 170B is inserted in the corresponding through-hole 160A of the sealing member 160 in a liquid-tight manner. Accordingly, each second ink flow passage 192 is in communication with an outflow passage 150 of the corresponding outflow tube 124. Ink stored in each ink chamber 111 flows to the recording head 39 through the corresponding outflow tube 124, the corresponding second ink flow passage 192, the corresponding first ink flow passage 191, the corresponding ink tube 32. When ink, stored in the ink chambers 111, is used due to ejection of ink from the recording head 39, air flows into the ink chambers 111 through the air communication ports 112.

Circular-shaped walls 122 are positioned at the front end portion of the upper wall 104. Each circular-shaped wall 122 has a cylindrical shape, and surrounds the corresponding one of communication ports 119 and the corresponding one of tank tubes 115. Each circular-shaped wall 122 extends diagonally upward and frontward from the front end portion of the upper wall 104 in an extending direction crossing both the direction of gravity and the horizontal direction. Each circular-shaped wall 122 extends parallel to the corresponding one of the tank tubes 115. Each tank tube 115 protrudes above the distal edge of the corresponding circular-shaped wall 122.

Each tank tube 115 is positioned inside the corresponding circular-shaped wall 122. Each tank tube 115 is a circular tube extending upward and frontward beyond the upper surface of the upper wall 104 in the extending direction, which crosses both the direction of gravity and the horizontal direction. Each tank tube 115 has an upper end which is open in the outside of the corresponding ink chamber 111. Each tank tube 115 has a lower end which is open in the inside of the corresponding ink chamber 111. Each tank tube 115 has an inner space providing communication between the outside and the inside of the corresponding ink chamber 111. Each tank tube 115 is positioned rearward of the center of the corresponding circular-shaped wall 122. In other words, the axes each of which extends through the center of the corresponding tank tube 115 are positioned rearward of the axes each of which extends through the center of the corresponding circular-shaped wall 122 when viewed in the extending direction, in which the tank tubes 115 extend. The distal end of each tank tube 115 is divided in the left-right direction into two lip portions. Since the distal end of each tank tube 115 is divided in the left-right direction into two lip portions, gaps are located in the upper portion and the lower portion of the distal end of the tank tube 115. Each tank tube 115 is an example of the first nozzle.

Each communication port 119 is positioned inside the corresponding circular-shaped wall 122 of the sloped surface 104A. The communication ports 119 extend through the upper wall 104 in the up-down direction. The front portion of each communication port 119 has a circular shape, and the rear portion of each communication port 119 has a rectangular shape. In other words, each communication port 119 has a quadrilateral shape whose front portion is convex outward in an arc shape. Each communication port 119 provides communication between the outside and inside of the corresponding ink chamber 111. Each communication port 119 is positioned frontward of the corresponding tank tube 115. Each communication port 119 is positioned below the corresponding tank tube 115. In other words, straight lines each of which passes through the center of the corresponding communication port 119 and extends in the extending direction, in which the tank tubes 115 extend, are positioned frontward of the axes of the tank tubes 115, each of which passes through the center of the corresponding tank tube 115, when viewed in the extending direction, in which the tank tubes 115 extend. Each communication port 119 is positioned frontward of the center of the corresponding circular-shaped wall 122. In other words, each straight line, passing through the center of the corresponding communication port 119 and extends in the extending direction, is positioned frontward of the corresponding axis of the circular-shaped wall 122, passing through the center of the circular-shaped wall 122, when viewed in the extending direction, in which the circular-shaped walls 122 extend. Each communication port 119 is an example of the filling port.

As illustrated in FIG. 4, the tank cover 110 holds the ink tank 100 while the tank cover 110 covers the front portion of the ink tank 100 from the front. The tank cover 110 includes a front wall 201, an upper wall 202, a right wall 203, a left wall 204, a lower wall 205, and a sloped wall 206. The front wall 201 covers the front portion of the ink tank 100. The front wall 201 has an opening 207. Part of the front wall 101 of the ink tank 100 is exposed to the front of the tank cover 110 through the opening 207. Here, “part of the front wall 101 of the ink tank 100 is exposed to the front of the tank cover 110 through the opening 207” signifies that at least a user can see part of the front wall 101 from the front of the tank cover 110 through the opening 207, and does not signify that part of the front wall 101 protrudes frontward of the tank cover 110 through the opening 207.

The upper wall 202 covers part of the front portion of the upper wall 104 of the ink tank 100. The right wall 203 covers part of the right wall 102 of the ink tank 100. The left wall 204 covers part of the left wall 103 of the ink tank 100. The lower wall 205 covers the lower wall 105 of the ink tank 100.

The sloped wall 206 is connected to the upper end of the front wall 201 and is connected to the front end of the upper wall 202. The sloped wall 206 is positioned above the circular-shaped walls 122 of the ink tank 100. The sloped wall 206 is positioned frontward of the circular-shaped walls 122 of the ink tank 100. In other words, the sloped wall 206 is positioned relative to the circular-shaped walls 122 in a direction in which the circular-shaped walls 122 extend from the front end portion of the upper wall 104 in the extending direction. The outer surface of the sloped wall 206 crosses both the direction of gravity and the horizontal direction. The outer surface of the sloped wall 206 slopes relative to the front-rear direction such that the outer surface of the sloped wall 206 extends downward as the outer surface of the sloped wall 206 extends frontward. The sloped wall 206 covers part of the sloped surface 104A of the upper wall 104 of the ink tank 100.

The sloped wall 206 has four through-holes 72. The four through-holes 72 are arranged in the left-right direction at intervals. Each through-hole 72 extends through the sloped wall 206 in the up-down direction. The sloped wall 206 has an inner peripheral surface defining the four through-holes 72. Hereinafter, the inner peripheral surface defining the through-hole 72 will be called the “inner peripheral surface of the through-hole 72”. The inner peripheral surface of each through-hole 72 has a cylindrical shape extending in a direction orthogonal to the outer surface of the sloped wall 206, i.e., extending upward and forward. In other words, each through-hole 72 has a cylindrical shape. Here, “a cylindrical shape” signifies the shape of an inner peripheral surface that surrounds an area to form an enclosed space. Thus, the shape of an opening defined by the inner peripheral surface does not necessarily have a circular shape. Furthermore, the inner peripheral surface of each through-hole 72 is regarded as having a cylindrical shape regardless of the length of the inner peripheral surface of the through-hole 72 extending in a direction in which the opening defined by the inner peripheral surface of the through-hole 72 faces, i.e., regardless of the thickness of the through-hole 72. The inner peripheral surface of each through-hole 72 surrounds the corresponding circular-shaped wall 122 when viewed from an above-front diagonal viewpoint. Each of the four through-holes 72 is positioned so as to correspond to the respective one of the four ink chambers 111. That is, each of the four through-holes 72 overlaps the corresponding one of the four ink chambers 111 when viewed from an above-front diagonal viewpoint. Each circular-shaped wall 122 is exposed to the outside of the tank cover 110 through the corresponding through-hole 72. Each communication port 119 is exposed to the outside of the tank cover 110 through the corresponding through-hole 72. As illustrated in FIG. 6, each tank tube 115 protrudes to the outside of the tank cover 110 through the corresponding through-hole 72.

Each through-hole 72 has the front portion and the rear portion. The front portion of the through-hole 72 has a circular shape and the rear portion of the through-hole 72 has a rectangular shape. In other words, each through-hole 72 has a quadrilateral shape whose front portion is convex outward in an arc shape. Specifically, the inner peripheral surface of each through-hole 72 has an inner curved surface 72A, a left inner flat surface 72B, a right inner flat surface 72C, and a rear inner flat surface 72D. The inner curved surface 72A is convex outward toward the front and the lower. The left inner flat surface 72B is connected to the left end of the inner curved surface 72A. The right inner flat surface 72C is connected to the right end of the inner curved surface 72A. The rear inner flat surface 72D connects the rear end of the left inner flat surface 72B and the rear end of the right inner flat surface 72C. Each inner curved surface 72A is positioned at the lower portion of the inner peripheral surface of the through-hole 72. The rear inner flat surface 72D has a shape such that the center portion of the rear inner flat surface 72D in the left-right direction is convex outward toward the upper and the rear. A slit 73 extends rearward from the rear inner flat surface 72D of each through-hole 72. Each slit 73 shares a space with the corresponding through-hole 72. Each slit 73 is positioned at the center of the rear inner flat surface 72D of the corresponding through-hole 72 in the left-right direction while the slit 73 shares a space with the corresponding through-hole 72. Each through-hole 72 is an example of the connection port. Each through-hole 72 may be provided on the ink tank 100.

As illustrated in FIG. 4, in each through-hole 72, key grooves 74 are selectively positioned the left and/or the right relative to the slit 73. Each key groove 74 extends rearward from the rear inner flat surface 72D of the through-hole 72 while each key groove 74 shares a space with the corresponding through-hole 72. In each through-hole 72, the presence or absence, position, and shape of each key groove 74 are different. Specifically, in the through-hole 72 positioned at the leftmost in FIG. 4, one key groove 74 is positioned rightward of the slit 73 and the other key groove 74 is positioned leftward of the slit 73. The length between the one key groove 74 and the slit 73 in the left-right direction is the same as the length between the other key groove 74 and the slit 73 in the left-right direction.

In the through-hole 72 which is the second from the left in FIG. 4, one key groove 74 is positioned rightward of the slit 73 and the other key groove 74 is positioned leftward of the slit 73. The length between the one key groove 74 (the right key groove 74) and the slit 73 in the left-right direction is longer than the length between the other key groove 74 (the left key groove 74) and the slit 73 in the left-right direction.

In the through-hole 72 which is the third from the left in FIG. 4, one key groove 74 is positioned rightward of the slit 73 and no key groove 74 is positioned leftward of the slit 73. The length of the one key groove 74 in the left-right direction is longer than the length of each key groove 74 in the left-right direction in the through-hole 72 which is the second from the left.

In the through-hole 72 which is positioned at the rightmost in FIG. 4, one key groove 74 is positioned rightward of the slit 73 and the other key groove 74 is positioned leftward of the slit 73. The length between the one key groove 74 (the right key groove 74) and the slit 73 in the left-right direction is shorter than the length between the other key groove 74 (the left key groove 74) and the slit 73 in the left-right direction. Each key groove 74 is an example of the connection portion.

As illustrated in FIG. 6, tank caps 127 are detachably attachable to the circular-shaped walls 122. Each tank cap 127 is a cylindrical member whose one end is closed. Each tank cap 127 has an outer shape such that the tank cap 127 is fixed in an attached orientation when part of the tank cap 127 is fitted in the corresponding slit 73 of the tank cover 110. In a state where the tank caps 127 are detached from the corresponding circular-shaped wall 122, the tank caps 127 are not connected to both the ink tank 100 and the tank cover 110, and are completely separated from both the ink tank 100 and the tank cover 110. That is, the ink tank set 51 does not include a holding member, which includes an arm or other members, for holding the tank caps 127 detached from the corresponding circular-shaped walls 122 in a connected state where the tank caps 127 are connected to the ink tank 100 or the tank cover 110.

Ink Bottle 80

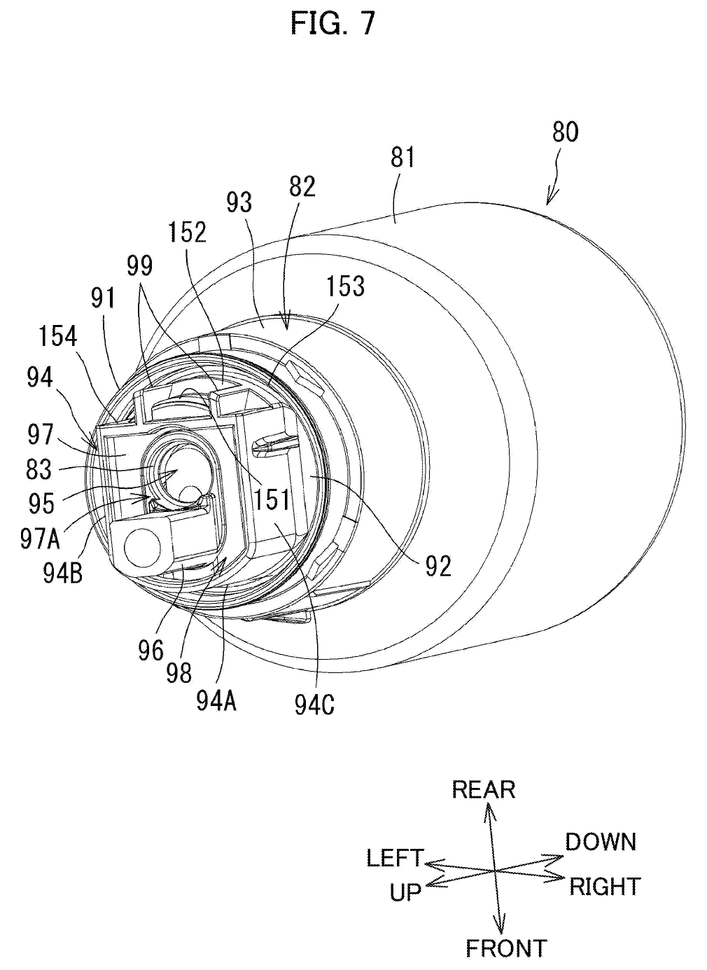

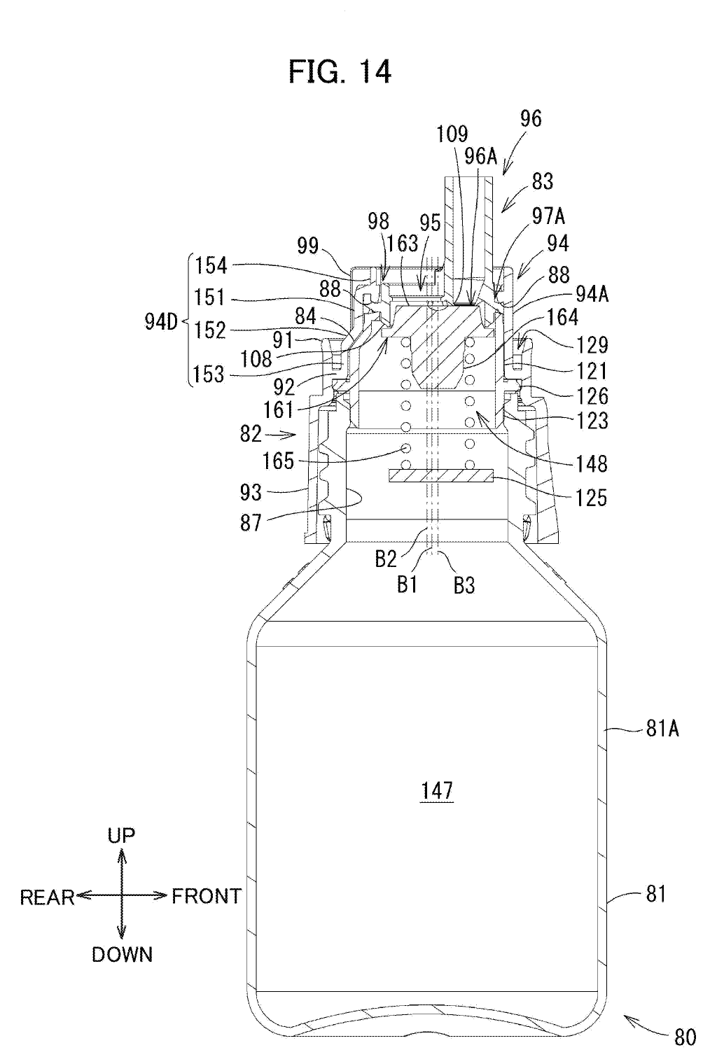

The ink bottle 80 illustrated in FIG. 7 is configured to be connected to the ink tank set 51. The ink bottle 80 is an example of the liquid container. The ink bottle 80 and the ink tank set 51 are examples of the system. As illustrated in FIGS. 7 and 14, the ink bottle 80 includes a bottle main body 81, a bottle cap 82, a support member 84 and a valve 161. The bottle main body 81 has a cylindrical shape. The upper end of the bottle main body 81 opens. Specifically, the bottle main body 81 has a main body container 81A and an opening portion 87. The main body container 81A defines an ink storage chamber 147 configured to store ink. The opening portion 87 is connected to the upper end of the main body container 81A. The inner space of the opening portion 87 is in communication with the ink storage chamber 147. The upper end of the opening portion 87 opens upward. The diameter of the opening portion 87 is smaller than the diameter of the main body container 81A. The bottle main body 81 and the bottle cap 82 are examples of the main body. The ink storage chamber 147 is an example of the first storage chamber.

Since the opening portion 87 is press-fitted in the inner space of the bottle cap 82, the bottle cap 82 is detachably attached to the opening portion 87. Note that the bottle cap 82 may be detachably attached to the opening portion 87 due to the inner peripheral surface of the bottle cap 82 and the outer peripheral surface of the opening portion 87 being threadedly engaged with each other. The bottle cap 82 includes a side wall 93, a bottom wall 92, a protrusion 94, a rubber 83, a key member 99, and an annular rib 91. The side wall 93 is a cylindrical wall extending in the up-down direction. The side wall 93 is connected to the opening portion 87 by one or more screws. Note that the side wall 93 may be mounted on the opening portion 87 by a hook. Also, the side wall 93 may be fixed to the opening portion 87 by welding such that the side wall 93 is not attachable to and detachable from the opening portion 87. The bottom wall 92 is an annular wall extending inward in a radial direction from the upper end of the side wall 93.

The protrusion 94 is a cylindrical wall extending upward from the bottom wall 92. The protrusion 94 is configured to be inserted in the corresponding through-hole 72 of the tank cover 110. The shape of the outer peripheral surface of the protrusion 94 corresponds to the shape of the inner peripheral surface of the corresponding through-hole 72 of the tank cover 110. In other words, the shape and size of the outer peripheral surface of the protrusion 94 are approximately the same as the shape and size of the inner peripheral surface of the corresponding through-hole 72. That is, the shape of the outer peripheral surface of the protrusion 94 in an axial direction in which the center axis B1 of the protrusion 94 extends corresponds to the shape of the through-hole 72 in the axial direction. The front portion of the outer peripheral surface of the protrusion 94 has a circular shape and the rear portion of the outer peripheral surface of the protrusion 94 has a rectangular shape in which straight sides are connected. In other words, the outer peripheral surface of the protrusion 94 has a quadrilateral shape whose front portion is convex outward in an arc shape.

Specifically, the outer peripheral surface of the protrusion 94 has an outer curved surface 94A, a left outer flat surface 94B, a right outer flat surface 94C, and a rear outer flat surface 94D. The outer curved surface 94A is convex frontward. The left outer flat surface 94B is connected to the left end of the outer curved surface 94A. The right outer flat surface 94C is connected to the right end of the outer curved surface 94A. The rear outer flat surface 94D connects the rear end of the left outer flat surface 94B and the rear end of the right outer flat surface 94C to each other. In a state where the protrusion 94 is inserted in the corresponding through-hole 72: the outer curved surface 94A corresponds to the inner curved surface 72A of the corresponding through-hole72; the left outer flat surface 94B corresponds to the right inner flat surface 72C of the corresponding through-hole 72; the right outer flat surface 94C corresponds to the left inner flat surface 72B of the corresponding through-hole 72. The rear outer flat surface 94D is at a position such that an opening 95 (described later) and a bottle tube 96 (described later) are positioned between the rear outer flat surface 94D and the outer curved surface 94A in the front-rear direction.

As illustrated in FIGS. 7 and 14, the rear outer flat surface 94D has an upper flat surface 154, an upper arc-shaped surface 151, a middle sloped surface 152, and a lower arc-shaped surface 153. The upper flat surface 154 is located at the upper end of the protrusion 94. The upper flat surface 154 forms straight sides of the rear portion of the outer peripheral surface of the protrusion 94 when the ink bottle 80 illustrated in FIG. 7 is viewed from above. The upper arc-shaped surface 151 is mainly continuous with the lower end of the part of the upper flat surface 154 positioned between the key members 99 in the left-right direction and illustrated in FIG. 7. The upper arc-shaped surface 151 is an arc-shaped surface convex rearward of the upper flat surface 154 when viewed from above. The middle sloped surface 152 is continuous with the lower end of the upper arc-shaped surface 151 and is continuous with the left-lower end and the right-lower end of the upper flat surface 154 in the left-right direction. The middle sloped surface 152 is sloped relative to the up-down direction such that the middle sloped surface 152 extends rearward as the middle sloped surface 152 extends downward. Accordingly, the inner space of the protrusion 94 expands between the upper end of the upper flat surface 154 and the lower end of the middle sloped surface 152 such that the inner space of the protrusion 94 becomes larger to the rear as the inner space of the protrusion 94 approaches the lower. The lower arc-shaped surface 153 is positioned from the lower end of the middle sloped surface 152 to the upper surface of the bottom wall 92. The lower arc-shaped surface 153 is an arc-shaped surface convex rearward when viewed from above. The lower arc-shaped surface 153 and the outer curved surface 94A are located at the same circumference. In a state where the protrusion 94 is inserted in the corresponding through-hole 72, the upper flat surface 154 and the upper arc-shaped surface 151, positioned above the upper end of the middle sloped surface 152 of the rear outer flat surface 94D, correspond to the rear inner flat surface 72D of the corresponding through-hole 72.

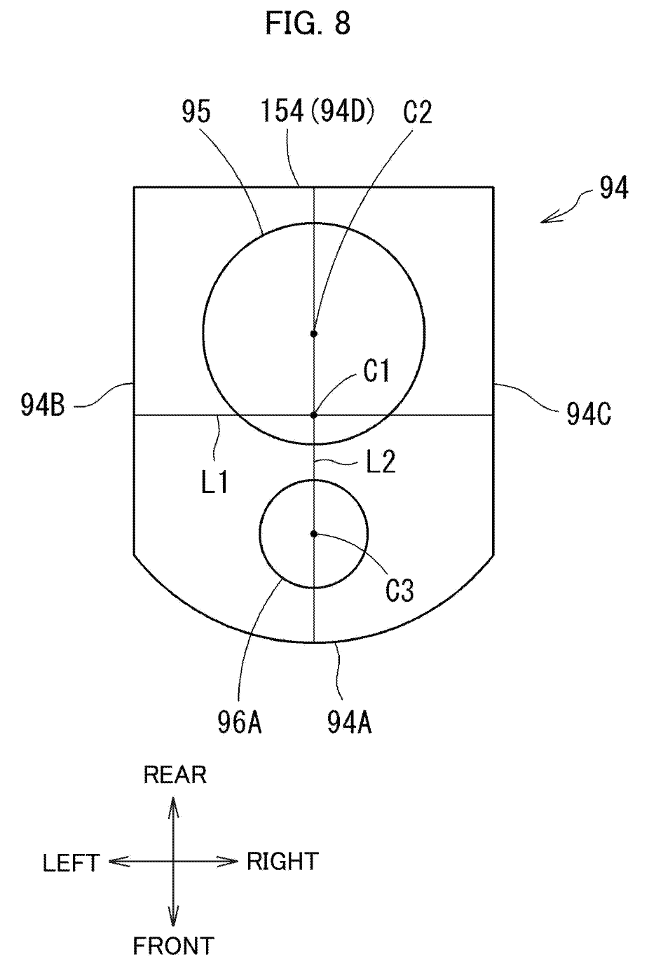

As illustrated in FIG. 8, the outer peripheral surface of the protrusion 94 in the axial direction does not have a rotational symmetry about a center C1 of the protrusion 94. The rotational symmetry signifies that an object coincides with itself two or more times when the object is rotated 360 degrees about its center as the rotational axis. For example, in a case where the outer peripheral surface of the protrusion 94 is an equilateral triangle, when the protrusion 94 is rotated 360 degrees about the center C1 as the rotational axis, the protrusion 94 coincides with itself three times. Hence, the outer peripheral surface of the protrusion 94 has the rotational symmetry about the center C1 of the protrusion 94. In the present embodiment, when the protrusion 94 is rotated 360 degrees about the center C1 as the rotational axis, the protrusion 94 coincides with itself only once. Hence the outer peripheral surface of the protrusion 94 does not have the rotational symmetry about the center C1. As a result, the protrusion 94 can be inserted into the corresponding through-hole 72 in only one direction. The center C1 is a point at which the central point of a line segment defining the length of the protrusion 94 in the left–right direction and the central point of a line segment defining the length of the protrusion 94 in the front–rear direction coincide with each other when the protrusion 94 is viewed from above. In the present embodiment, the center C1 is a point at which the central point of a line segment L1 connecting the left outer flat surface 94B and the right outer flat surface 94C, and the central point of a line segment L2 connecting the front end of the outer curved surface 94A and the upper flat surface 154 of the rear outer flat surface 94D coincide with each other when the protrusion 94 is viewed from above.

As illustrated in FIG. 14, a center axis B1 passing through the center C1 defined as described above is offset relative to a center axis B2 passing through the center of the opening portion 87. Specifically, the center axis B1 is offset frontward relative to the center axis B2. In other words, the center C1 is offset frontward relative to the center of the opening portion 87. A center axis passing through the center of a circle having the circumferential at which the lower arc-shaped surface 153 and the outer curved surface 94A are located coincides with the center axis B2. A valve accommodating space 148 in which the valve 161 is accommodated is defined by the inner surface of the protrusion 94 and the opening portion 87. The opening portion 87 and the protrusion 94 are examples of the neck portion. The opening portion 87 is an example of the first neck portion. The upper portion of the protrusion 94 positioned above the upper end of the middle sloped surface 152 is an example of the second neck portion. The valve accommodating space 148 is an example of the accommodating space. The front is an example of the offset direction.

As illustrated in FIG. 7, the protrusion 94 includes an upper wall 97 positioned at the upper end portion of the protrusion 94. The upper wall 97 is positioned slightly below the upper end of the protrusion 94. The upper wall 97 has an upper surface orthogonal to the up-down direction. The upper wall 97 has a flat plate shape extending in the front-rear direction and the left-right direction. A recessed portion 98 is defined by the upper surface of the upper wall 97 and the inner peripheral surface of the protrusion 94. The inner peripheral surface of the recessed portion 98 is parallel to the outer peripheral surface of the protrusion 94.

An opening 97A is located at the upper surface of the upper wall 97 of the protrusion 94. The opening 97A has an oblong shape extending in the front-rear direction. The opening 97A extends through the upper wall 97 in the up-down direction. The opening 97A is defined by the upper wall 97. Part of the rubber 83 is exposed to the outside through the opening 97A.

As illustrated in FIG. 14, a protrusion 88 protruding downward from the upper wall 97 is provided on the protrusion 94. The protrusion 88 has an oblong shape and extends along the opening 97A.

The key member 99 extends rearward from the rear outer flat surface 94D of the outer peripheral surface of the protrusion 94. The key member 99 is configured to be fitted in the key groove 74. The cross-sectional shape of the key member 99 taken along a plane orthogonal to the up-down direction is not rotationally symmetrical about the center C1 of the protrusion 94. The position and shape of the key member 99 coincide with the position and shape of the key groove 74 of the corresponding through-hole 72 to which the corresponding ink bottle 80 is connected. In other words, the four liquid bottles 80 respectively store inks of different colors from one another, the colors being selected from black, yellow, cyan, and magenta. In the four liquid bottles 80, the positions and shapes of the key members 99 relative to the respective rear outer flat surfaces 94D are different from one another. In FIG. 7, the key member 99 of the ink bottle 80 which coincides with the leftmost through-hole 72 of the tank cover 110 is illustrated. The key member 99 is an example of the key portion.

The annular rib 91 is positioned at the outer peripheral portion of the upper surface of the bottom wall 92. The annular rib 91 is spaced outward from the protrusion 94. The annular rib 91 protrudes upward from the upper surface of the bottom wall 92. The annular rib 91 extends in an annular shape along the outer peripheral portion of the upper surface of the bottom wall 92. The annular rib 91 surrounds the outer peripheral surface of the protrusion 94. Accordingly, an ink holding space 129 is defined by the inner peripheral surface of the annular rib 91, the outer peripheral surface of the protrusion 94, and the upper surface of the bottom wall 92. The ink holding space 129 has an annular shape.

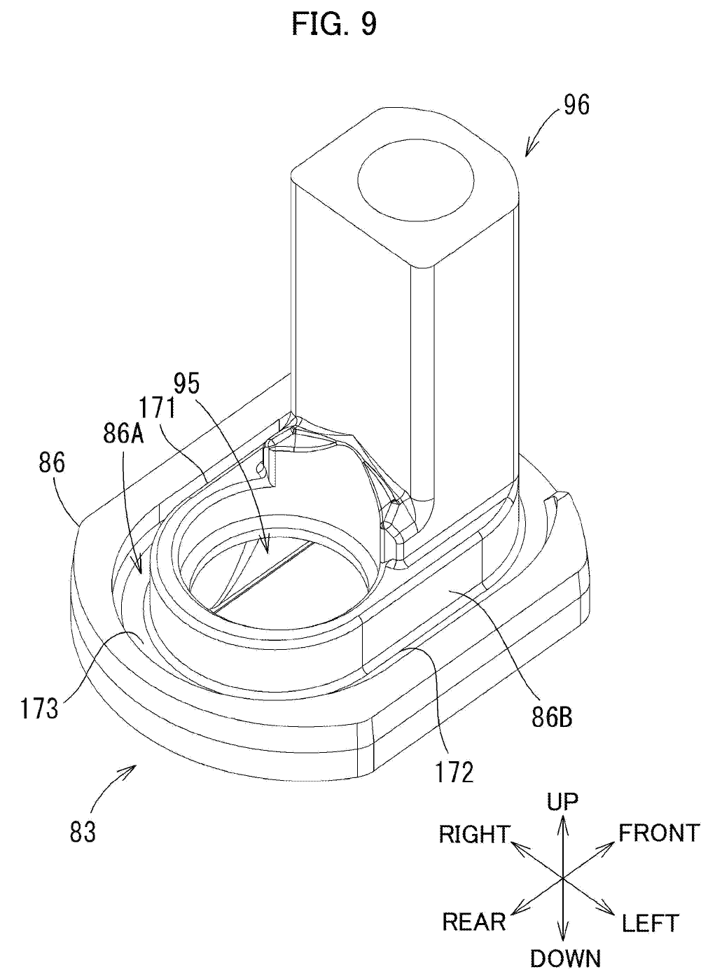

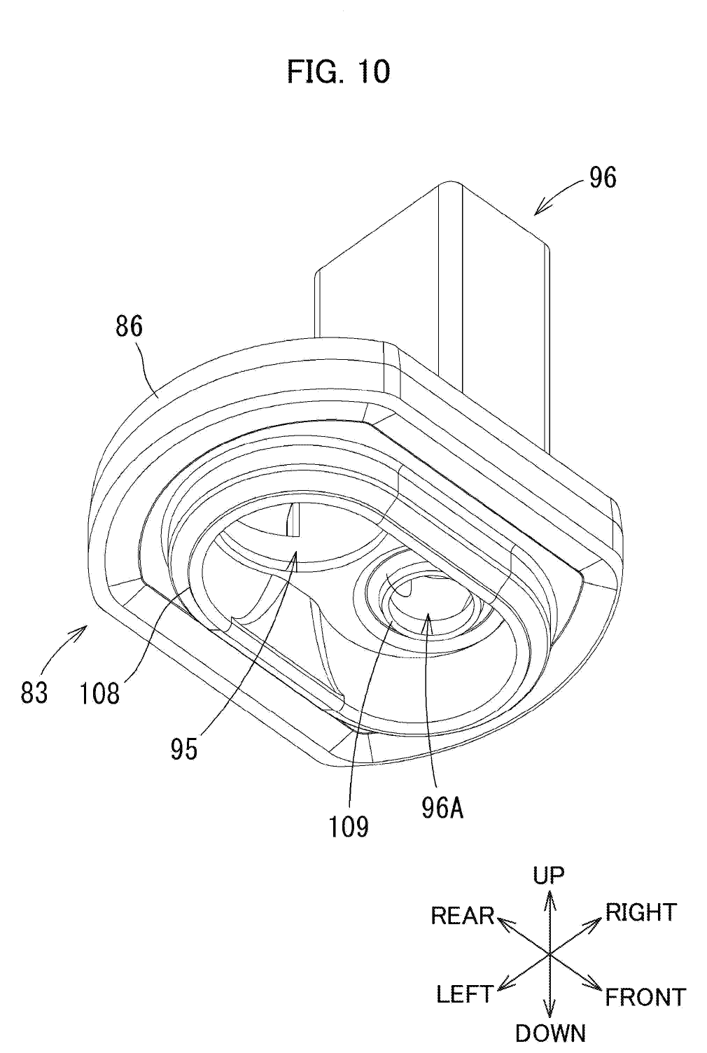

As illustrated in FIGS. 7 and 14, the rubber 83 is positioned at the opening 97A of the upper wall 97 of the protrusion 94. The rubber 83 is made of rubber. As illustrated in FIGS. 9 and 10, the rubber 83 has a base portion 86, an opening 95, and the bottle tube 96. The base portion 86 has an oblong shape, in which the ends of the base portion 86 in the front-rear direction are curved and the ends of the base portion 86 in the left-right direction extends linearly in the front-rear direction. A groove 86A is located at the upper surface of the base portion 86. The groove 86A extends along the shape of the base portion 86 and has an oblong shape. The groove 86A is recessed downward from the upper surface of the base portion 86.

Specifically, the groove 86A has a right straight groove 171, a left straight groove 172, a rear curved groove 173. The right straight groove 171 is located at the right portion of the base portion 86. The right straight groove 171 extends in the front-rear direction. The left straight groove 172 is located at the left portion of the base portion 86. The left straight groove 172 extends in the front-rear direction. The right straight groove 171 and the left straight groove 172 face each other in the left-right direction such that the opening 95 and the bottle tube 96 are positioned between the right straight groove 171 and the left straight groove 172. The rear curved groove 173 is located at the rear portion of the base portion 86. The rear curved groove 173 is connected to both the rear end of the right straight groove 171 and the rear end of the left straight groove 172. The protrusion 88 is fitted in the groove 86A. Each of the right straight groove 171 and the left straight groove 172 receives outward force in the left-right direction from the protrusion 88. As a result, the base portion 86 is maintained in a state where the base portion 86 is urged outward in the left-right direction.

The base portion 86 has a protrusion 86B. The protrusion 86B is positioned inward of the groove 86A and protrudes upward. The protrusion 86B has an oblong shape, in which the ends of the protrusion 86B in the front-rear direction are curved and the ends of the protrusion 86B in the left-right direction extends linearly in the front-rear direction. The protrusion 86B is received in the opening 97A of the bottle cap 82.

The opening 95 has a circular shape and extends through the protrusion 86B in the up-down direction. The opening 95 provides communication between the valve accommodating space 148 of the ink bottle 80 and the outside.

The bottle tube 96 has an opening 96A. The bottle tube 96 is adjacent to the opening 95 and positioned frontward of the opening 95. The bottle tube 96 extends upward from the protrusion 86B. The bottle tube 96 has a cylindrical body having an opening which is open upward and an opening which is open downward. The inner space of the bottle tube 96 connects the inner space of the ink bottle 80 and the outside to each other.

The outer shape of the bottle tube 96 has a quadrilateral shape corresponding to the shape of the communication port 119 of the ink tank 100. That is, the outer shape of the front portion of the bottle tube 96 is circular and the outer shape of the rear portion of the bottle tube 96 is rectangular. In other words, the bottle tube 96 has an outer shape in which the front side of the rectangle is convex in an arc shape. The cross-section of the inner space of the bottle tube 96 has a circular shape. Since the rear portion of the outer shape of the bottle tube 96 is rectangular, the thickness of the bottle tube 96 at the corner portions of the bottle tube 96 having a rectangle shape are greater than the thickness of the front portion of the bottle tube 96. As a result, the bottle tube 96 is less likely to be deformed rearward. The bottle tube 96 is an example of the second nozzle.

As illustrated in FIG. 8, the opening 95 is located rearward of the center C1 of the protrusion 94. The outer peripheral surface of the protrusion 94 is not rotationally symmetrical about a center C2 of the opening 95. The opening 96A of the bottle tube 96 is located frontward of the center C1 of the protrusion 94. The opening 96A is located frontward of the opening 95. The bottle tube 96 extends upward from the opening 96A. The length between the opening 96A and the opening 95 in the front-rear direction is less than or equal to the one-half of the inner diameter of the opening 96A. The outer peripheral surface of the protrusion 94 is not rotationally symmetrical about a center C3 of the opening 96A. The opening 95 is an example of the first opening. The opening 96A is an example of the second opening.

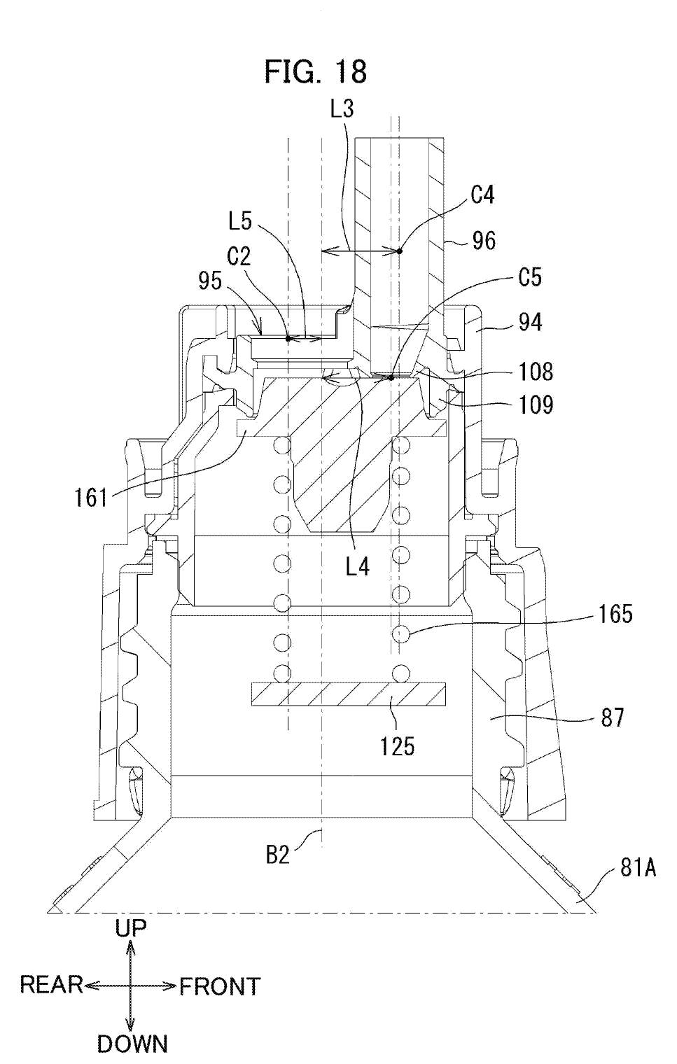

As illustrated in FIG. 18, a length L3 is a length between the center axis B2 and a center C4 of the inner peripheral surface of the bottle tube 96 in the front-rear direction. A length L4 is a length between the center axis B2 and a center C5 in the front-rear direction of a lip 108 (described later) in the front-rear direction. The length L3 is longer than the length L4. A length L5 is a length between the center axis B2 and the center C2 of the opening 95 in the front-rear direction. The length L4 is longer than the length L5.

As illustrated in FIG. 10, the lip 108 and a lip 109 are positioned on the lower surface of the base portion 86. The lip 108 and the lip 109 are portions which constitute a seal for sealing. The lip 108 and the lip 109 are protruding portions which are elastically deformable. The lip 108 extends downward in the up-down direction from the lower surface of the base portion 86. The lip 108 has an annular shape in which a first length of the lip 108 in the front-rear direction is longer than a second length of the lip 108 in the left-right direction. Specifically, the lip 108 has an oblong shape, in which the ends of the lip 108 in the front-rear direction are curved and the ends of the lip 108 in the left-right direction extend linearly in the front-rear direction. The opening 95 and the opening 96A are located inward of the lip 108. In other words, the lip 108 surrounds the opening 95 and the opening 96A. The lip 108 elastically deforms by the entire periphery of the lip 108 contacting the valve 161, thereby forming a liquid-tight seal with the valve 161. The lip 108 is an example of the lip.

The lip 109 extends downward in the up-down direction from the lower surface of the protrusion 86B at the peripheral edge of the opening 96A. The lip 109 is positioned inward of the lip 108. The lip 109 has a circular shape. The lower end of the lip 109 is positioned above the lower end of the lip 108. The lip 109 elastically deforms by contacting the valve 161, thereby forming a liquid-tight seal with the valve 161.

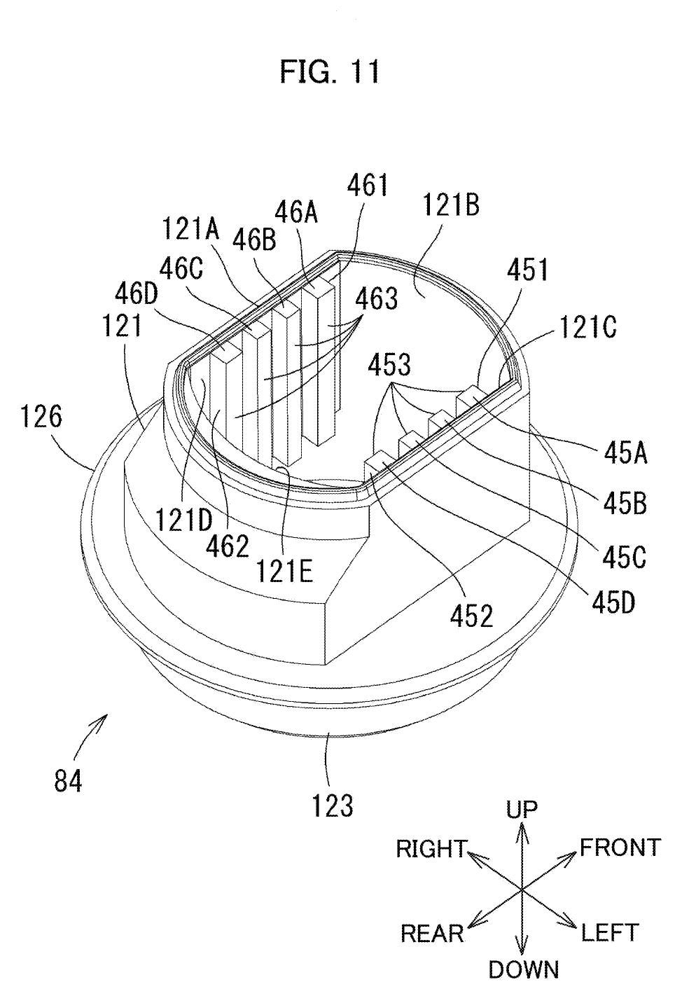

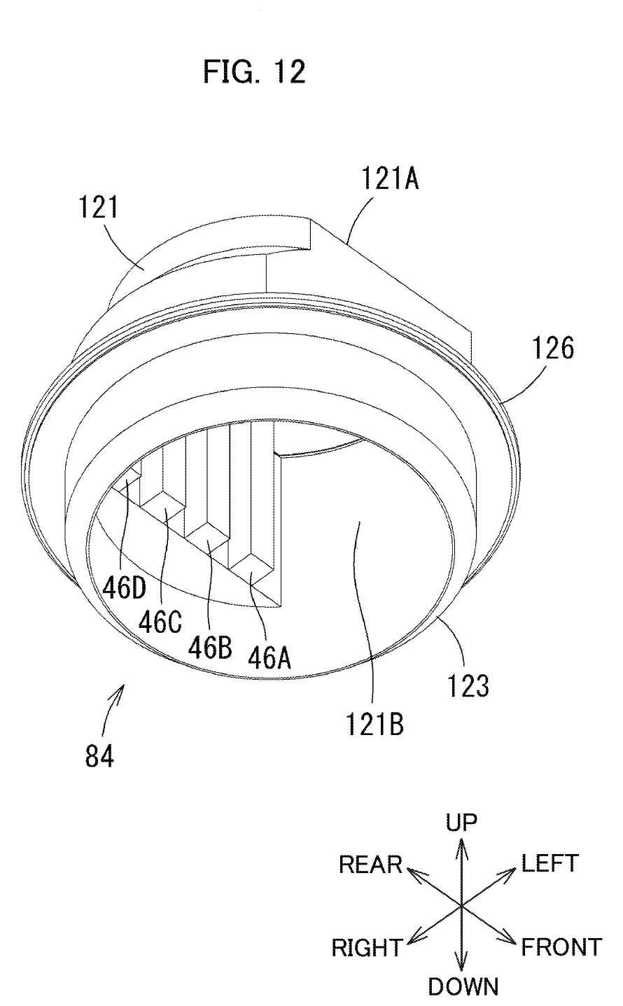

As illustrated in FIGS. 11, 12, and 14, the support member 84 is positioned inside the valve accommodating space 148. The support member 84 has an upper portion 121, a flange 126, and a lower portion 123.

The upper portion 121 has a cylindrical body having an oblong shape when viewed from above. The upper portion 121 is positioned inward of the protrusion 94 of the bottle cap 82. An upper end surface 121A of the upper portion 121 is in contact with the lower surface of the rubber 83 at the position outward of the lip 108. The shape of the upper end surface 121A is approximately the same as the outer shape of the base portion 86 of the rubber 83. Also, the shape of the upper end surface 121A is approximately the same as the oblong shape of the lip 108. The rubber 83 is sandwiched in the up-down direction between the upper wall 97 of the protrusion 94 of the bottle cap 82 and the upper portion 121 of the support member 84. The lip 108 of the rubber 83 is positioned inward of the upper portion 121 and is in contact with the upper portion 121. In other words, the upper portion 121 is in contact with the outer portion of the lip 108.

The inner peripheral surface of the upper portion 121 has a front inner curved surface 121B, a left inner flat surface 121C, a right inner flat surface 121D, and a rear inner curved surface 121E. The front inner curved surface 121B is convex toward the front. The left inner flat surface 121C is connected to the left end of the front inner curved surface 121B. The right inner flat surface 121D is connected to the right end of the front inner curved surface 121B. The rear inner curved surface 121E is convex toward the rear. The rear inner curved surface 121E connects the rear end of the left inner flat surface 121C and the rear end of the right inner flat surface 121D to each other. The rear inner curved surface 121E is sloped relative to the up-down direction such that the rear inner curved surface 121E extends rearward as the rear inner curved surface 121E extends downward. Hence, the inner space of the upper portion 121 expands rearward as the inner space of the upper portion 121 approaches the lower.

The upper portion 121 has four left protruding portions 45A, 45B, 45C, and 45D, and four right protruding portions 46A, 46B, 46C, and 46D. Each of the left protruding portions 45A, 45B, 45C, and 45D protrudes rightward from the left inner flat surface 121C. The four left protruding portions 45A, 45B, 45C, and 45D are arranged at intervals in the front-rear direction. Each of the left protruding portions 45A, 45B, 45C, and 45D extends in the up-down direction from the upper end portion of the upper portion 121 to the lower end portion of the upper portion 121. Each of the left protruding portions 45A, 45B, 45C, and 45D has a quadrangular prism shape. Each of the left protruding portions 45A, 45B, 45C, and 45D has a front surface 451 facing frontward, a rear surface 452 facing rearward, and a right surface 453 facing rightward. Each of the left protruding portions 45B, 45C, and 45D is an example of the third protruding portion.

The four right protruding portions 46A, 46B, 46C, and 46D extend leftward from the right inner flat surface 121D. The four right protruding portions 46A, 46B, 46C, and 46D are arranged at intervals in the front-rear direction. Each of the right protruding portions 46A, 46B, 46C, and 46D extends in the up-down direction from the upper end portion of the upper portion 121 to the lower end portion of the upper portion 121. Each of the four right protruding portions 46A, 46B, 46C, and 46D has a quadrangular prism shape. Each of the four right protruding portions 46A, 46B, 46C, and 46D has a front surface 461 facing frontward, a rear surface 462 facing rearward, a left surface 463 facing leftward. Each of the right protruding portions 46B, 46C, and 46D is an example of the third protruding portion.

The flange 126 is a circular plate extending outward from the lower end of the outer peripheral surface of the upper portion 121. The flange 126 does not protrude to the inner space of the upper portion 121. The outer diameter of the flange 126 is greater than the inner diameter of the opening portion 87 of the bottle main body 81. The outer diameter of the flange 126 is smaller than the inner diameter of the side wall 93 of the bottle cap 82. The flange 126 is in contact with the upper surface of the opening portion 87 of the bottle main body 81. The flange 126 is sandwiched by the upper surface of the opening portion 87 of the bottle main body 81 and the bottom wall 92 of the bottle cap 82 in the up-down direction. Hence, the support member 84 is fixed inside the valve accommodating space 148.

The lower portion 123 has a cylindrical shape extending downward from the flange 126. The outer diameter of the lower portion 123 is smaller than the inner diameter of the side wall 93 of the bottle cap 82. The outer diameter of the lower portion 123 is slightly smaller than the inner diameter of the opening portion 87 of the bottle main body 81.

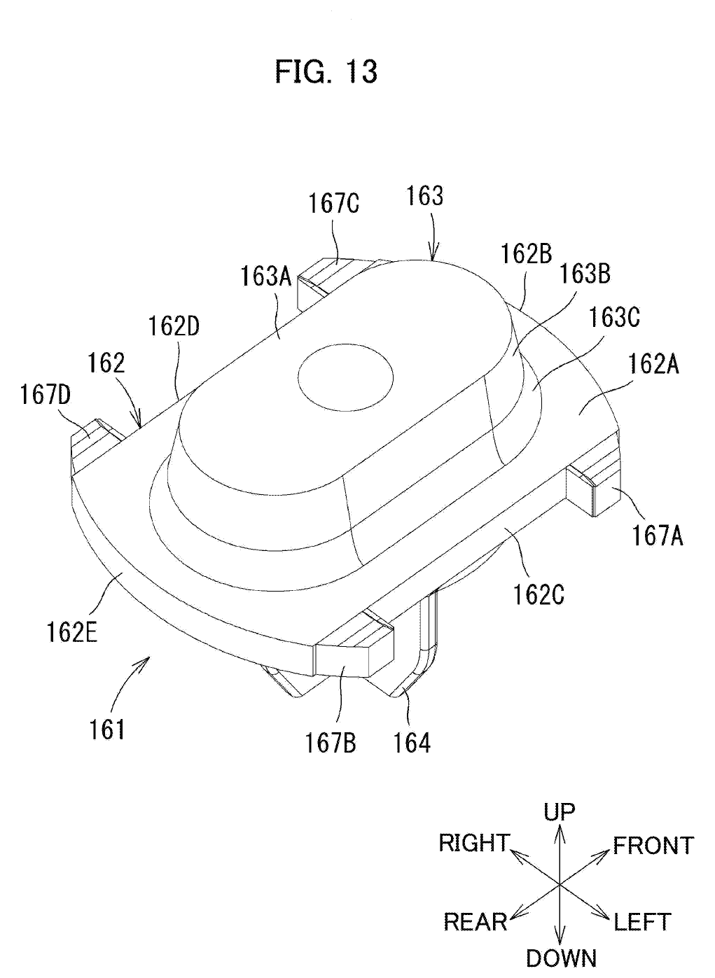

As illustrated in FIGS. 13 and 14, the valve 161 is positioned inside the valve accommodating space 148. The valve 161 has a flat surface portion 162, four guide portions 167A, 167B, 167C, and 167D, a protruding portion 163, and a spring seat 164.

The flat surface portion 162 is configured to be positioned inward of the upper portion 121 of the support member 84. In a state where the flat surface portion 162 is positioned inward of the upper portion 121 of the support member 84, the valve 161 is guided by the support member 84, and therefore the valve 161 is movable in the up-down direction. The up-down direction is an example of the movement direction.

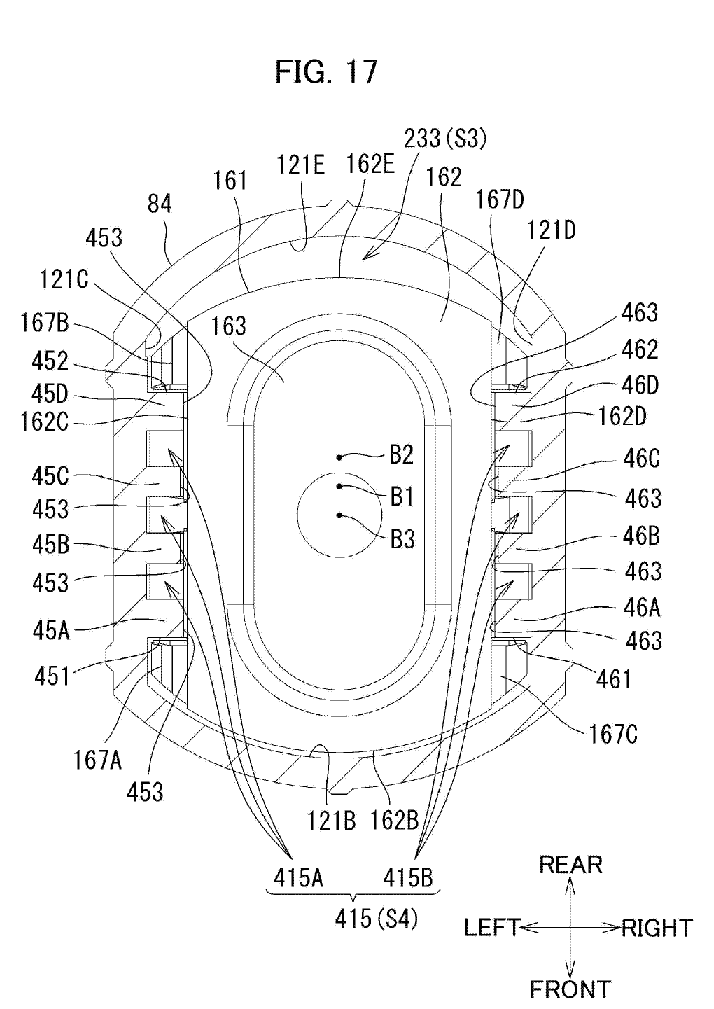

The flat surface portion 162 has a plate shape extending in the front-rear direction and the left-right direction. The outer peripheral surface of the flat surface portion 162 has an oblong shape. Specifically, the outer peripheral surface of the flat surface portion 162 has a front outer curved surface 162B convex toward the front, a left outer flat surface 162C facing leftward, a right outer flat surface 162D facing rightward, and a rear outer curved surface 162E convex toward the rear. The front outer curved surface 162B and the rear outer curved surface 162E are located at the same circumference. As illustrated in FIG. 17, the left outer flat surface 162C of the flat surface portion 162 is in contact with the right surface 453 of each of the four left protruding portions 45A, 45B, 45C, and 45D. The right outer flat surface 162D is in contact with the left surface 463 of each of the four right protruding portions 46A, 46B, 46C, and 46D. The left protruding portion 45A is an example of the first protruding portion. The right surface 453 of the left protruding portion 45A is an example of the second contact surface. The right protruding portion 46A is an example of the second protruding portion. The left surface 463 of the right protruding portion 46A is an example of the fourth contact surface. An upper surface 162A of the flat surface portion 162 is a flat surface. As illustrated in FIGS. 14 and 17, the center axis B3 passing through the center of the flat surface portion 162 is offset frontward relative to the center axis B2 of the opening portion 87. The center of the flat surface portion 162 coincides with the center of a circle having the circumference at which the front outer curved surface 162B and the rear outer curved surface 162E are located. The center axis B3 is an example of the center axis.

As illustrated in FIGS. 13 and 17, the four guide portions 167A, 167B, 167C, and 167D are positioned at the outer peripheral surface of the flat surface portion 162. The guide portion 167A protrudes leftward from the front end portion of the left outer flat surface 162C of the outer peripheral surface of the flat surface portion 162. The guide portion 167A is in contact with the front surface 451 of the left protruding portion 45A. The front surface 451 of the left protruding portion 45A is an example of the first contact surface. The guide portion 167B protrudes leftward from the rear end portion of the left outer flat surface 162C of the outer peripheral surface of the flat surface portion 162. The guide portion 167B is in contact with the rear surface 452 of the left protruding portion 45D. The guide portion 167C protrudes rightward from the front end portion of the right outer flat surface 162D of the outer peripheral surface of the flat surface portion 162. The guide portion 167C is in contact with the front surface 461 of the right protruding portion 46A. The front surface 461 of the right protruding portion 46A is an example of the third contact surface. The guide portion 167D protrudes rightward from the rear end portion of the right outer flat surface 162D of the outer peripheral surface of the flat surface portion 162. The guide portion 167D is in contact with the rear surface 462 of the right protruding portion 46D. The flat surface portion 162 is an example of the base portion.

As illustrated in FIG. 13, the protruding portion 163 is positioned inward of the outer peripheral surface of the flat surface portion 162. The upper surface 162A is positioned around the protruding portion 163. The protruding portion 163 protrudes upward from the upper surface 162A toward the opening 95 and the opening 96A. The protruding portion 163 has an upwardly tapered shape such that the cross-sectional area of the protruding portion 163 taken along the front-rear direction and the left-right direction gradually decreases. The protruding portion 163 has an upper surface 163A, a side surface 163B, and a curved surface 163C.

The upper surface 163A of the protruding portion 163 is smaller than the upper surface 162A of the flat surface portion 162. The upper surface 163A has an oblong shape, which is similar to the outer shape of the lip 108 of the rubber 83. The outer shape of the upper surface 163A is smaller than the outer shape of the inner surface of the lip 108. The upper surface 163A is configured to contact the lip 109 of the rubber 83. The side surface 163B extends downward from the outer edge of the upper surface 163A. The curved surface 163C connects the lower end of the side surface 163B and the upper surface 162A of the flat surface portion 162. The curved surface 163C faces diagonally upward and is recessed downward. The protruding portion 163 is configured to be positioned inward of the lip 108 of the rubber 83. The curved surface 163C is configured to contact the lip 108 of the rubber 83. In a state where the curved surface 163C is in contact with the lip 108, the upper surface 163A is configured to contact the lip 109 of the rubber 83. The protruding portion 163 is an example of the stepped portion.

The spring seat 164 is positioned at the lower surface of the flat surface portion 162.

As illustrated in FIG. 14, a spring seat 125 is positioned below the support member 84 inside the bottle main body 81. The spring seat 125 is fixed to the bottle main body 81 or the support member 84, for example. A coil spring 165 is positioned between the valve 161 and the spring seat 125. The coil spring 165 urges the valve 161 upward.

The valve 161 is movable between the closed position and the open position in the up-down direction. As illustrated in FIG. 14, when the valve 161 is at the closed position, the upper surface 163A of the protruding portion 163 is in contact with the lip 109. As a result, ink does not enter into the inner space of the bottle tube 96. Also, when the valve 161 is at the closed position, the lip 108 is in contact with the curved surface 163C of the protruding portion 163. As a result, ink is less likely to enter into the inner space of the lip 108 of the rubber 83. Also, since the protruding portion 163 is positioned inward of the lip 108 when the valve 161 is at the closed position, the likelihood that the lip 108 is displaced inward can be reduced. Note that the upper portion 121 of the support member 84 is positioned outward of the lip 108, the likelihood that the lip 108 is displaced outward can be also reduced.

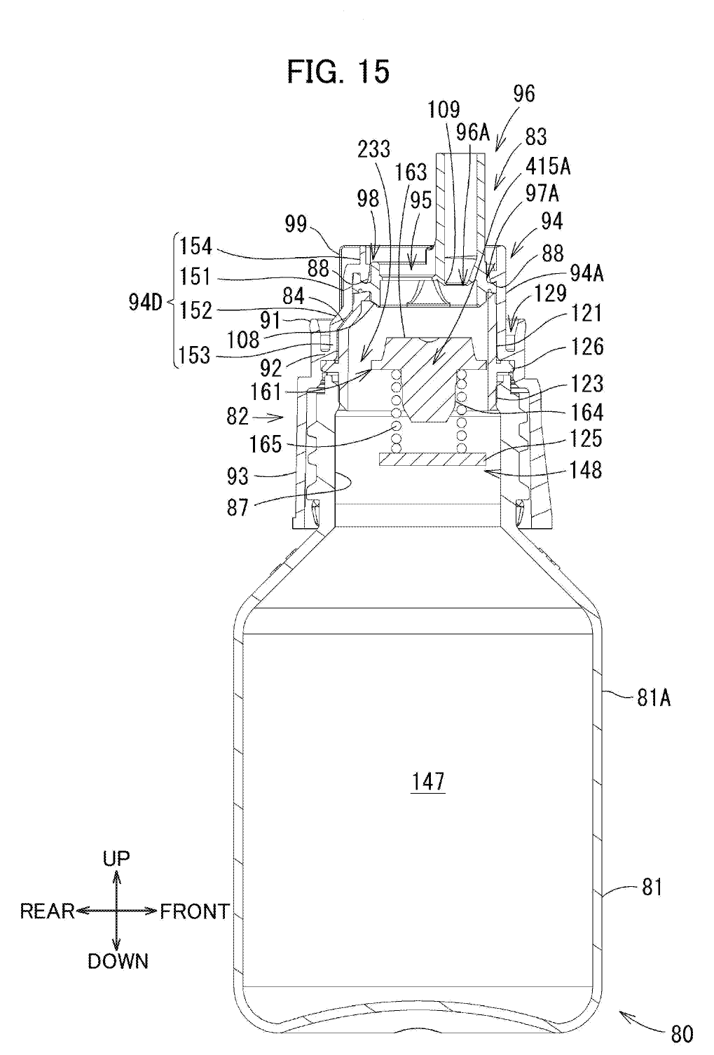

As illustrated in FIG. 15, the opening position of the valve 161 is a position in which the valve 161 moves downward against the urging force of the coil spring 165. When the valve 161 is at the opening position, the protruding portion 163 of the valve 161 is positioned below the lower end of the lip 108 of the rubber 83. Hence, the upper surface 163A of the protruding portion 163 is apart from the lip 109, and the curved surface 163C is apart from the lip 108.

As illustrated in FIG. 17, the valve 161 positioned at the open position and the support member 84 define an air flow passage 233 and an ink flow passage 415. The air flow passage 233 is defined by the rear inner curved surface 121E, the left inner flat surface 121C, and the right inner flat surface 121D of the support member 84, and the rear outer curved surface 162E of the flat surface portion 162. The air flow passage 233 provides communication between the ink storage chamber 147 and the opening 95. Since the protruding portion 163 is positioned on the upper surface 162A of the flat surface portion 162, the air flow passage 233 at the protruding portion 163 extends further in the front-rear direction than the air flow passage 233 at the flat surface portion 162 extends in the front-rear direction.

The ink flow passage 415 includes left ink flow passages 415A and right ink flow passages 415B. The left ink flow passages 415A are defined by the left outer flat surface 162C of the flat surface portion 162 and the four left protruding portions 45A, 45B, 45C, and 45D. In other words, there are the three left ink flow passages 415A provided leftward of the valve 161. The three left ink flow passages 415A are arranged at intervals in the front-rear direction. The right ink flow passages 415B are defined by the right outer flat surface 162D of the flat surface portion 162 and the four right protruding portions 46A, 46B, 46C, and 46D. In other words, there are the three right ink flow passages 415B rightward of the valve 161. The three right ink flow passages 415B are arranged at intervals in the front-rear direction. Each left ink flow passage 415A provides communication between the ink storage chamber 147 and the opening 96A. Each right ink flow passage 415B provides communication between the ink storage chamber 147 and the opening 96A. Since the protruding portion 163 is positioned on the upper surface 162A of the flat surface portion 162, each left ink flow passage 415A at the protruding portion 163 extends further in the left-right direction than the left ink flow passage 415A at the flat surface portion 162 extends in the left-right direction. Also, since the protruding portion 163 is positioned on the upper surface 162A of the flat surface portion 162, each right ink flow passage 415B at the protruding portion 163 extends further in the left-right direction than the right ink flow passage 415B at the flat surface portion 162 extends in the left-right direction.

The air flow passage 233 is larger than the ink flow passage 415. Specifically, an area S3 of the air flow passage 233 is larger than an area S4 which is the sum of the areas of the left ink flow passages 415A and the areas of the right ink flow passages 415B. The area S3 of the air flow passage 233 is a cross-sectional area taken along a horizontal plane extending in the horizontal direction, the horizontal plane having the flat surface portion 162 positioned at the open position. The area S4 is the sum of the areas of cross-sectional areas of the left ink flow passages 415A and cross-sectional areas of the right ink flow passages 415B. The cross-sectional areas of the left ink flow passages 415A are taken along a horizontal plane extending in the horizontal direction, the horizontal plane having the flat surface portion 162 positioned at the open position. The cross-sectional areas of the right ink flow passages 415B are taken along a horizontal plane extending in the horizontal direction, the horizontal plane having the flat surface portion 162 positioned at the open position. The air flow passage 233 is an example of the fluid flow passage. The ink flow passage 415 is an example of the liquid flow passage. Each left ink flow passage 415A is an example of the first liquid passage. Each right ink flow passage 415B is an example of the second liquid passage.

Connection Between the Ink Bottle 80 and the Ink Tank 100

Firstly, since a user directly visually recognizes ink stored inside the ink bottle 80 from the outside of the main body container 81A or the user checks a color or a name of color indicated by a label on the ink bottle 80, the user identifies a color of ink storing in the inside of the ink bottle 80. Also, since the user checks colors or names of colors indicated by labels each of which provided on the portion of the front wall 101 of the ink tank 100 corresponding to the corresponding one of the ink chambers 111, and by labels each of which provided on the portion of the tank cover 110 corresponding to the corresponding one of the ink chambers 111, the user identifies a color to be supplied to the corresponding one of the ink chambers 111. Accordingly, the user identifies the corresponding one of the four through-holes 72 of the tank cover 110 into which the corresponding ink bottle 80 is inserted. Next, the user identifies a direction in which the protrusion 94 of the ink bottle 80 is inserted into the corresponding through-hole 72 of the tank cover 110. At this time, since the outer curved surface 94A and the rear outer flat surface 94D are positioned such that the opening 95 and the bottle tube 96 are positioned between the outer curved surface 94A and the rear outer flat surface 94D in the front-rear direction, the user can identify easily the direction in which the protrusion 94 is inserted into the corresponding through-hole 72.

For example, the user inserts the protrusion 94 into the leftmost through-hole 72. At this time, the key member 99 is inserted into the key groove 74 of the leftmost through-hole 72. At this time, in a case where the user mistakenly attempts to insert the protrusion 94 into the through-hole 72 which is the second from the left, the key member 99 cannot be inserted into the key groove 74. As a result, the likelihood that the ink bottle 80 is connected to an incorrect position can be reduced.

Upon the key member 99 being fitted in the corresponding key groove 74, the bottle tube 96 is inserted in the corresponding communication port 119 of the ink tank 100 and the corresponding tank tube 115 is inserted in the opening 95 of the ink bottle 80. At this time, the valve 161 is pressed frontward and upward by the corresponding tank tube 115, and accordingly the valve 161 moves from the closed position toward the opening position against an urging force of the coil spring 165. As a result, the ink bottle 80 is connected to the ink tank 100.

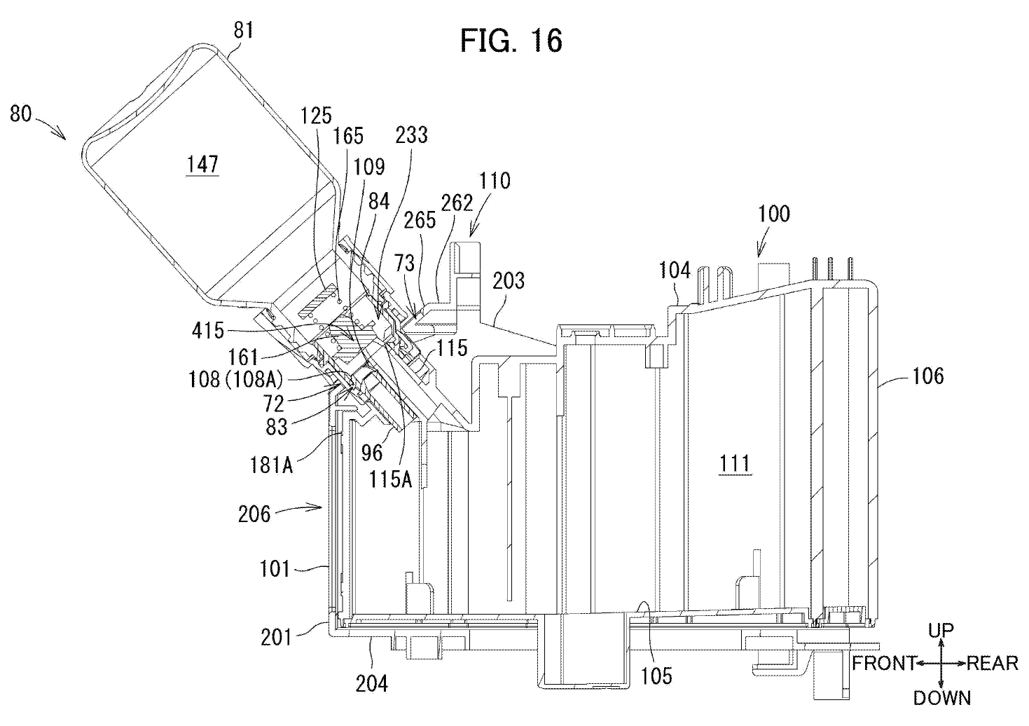

As illustrated in FIG. 16, in a state where the ink bottle 80 is connected to the ink tank 100: the bottle tube 96 is positioned below the corresponding tank tube 115. In the up-down direction, the position of the distal end of the bottle tube 96 coincides with the position of the corresponding upper line 181A. A base end portion 115A, at which the tank tube 115 begins to branch into two lip portions, coincides with an edge 108A of the lip 108 in the extending direction, in which the tank tubes 115 extend. The air flow passage 233 is located above the ink flow passage 415. The outer curved surface 94A of outer peripheral surface of the protrusion 94 is supported by the inner curved surface 72A of the inner peripheral surface of the corresponding through-hole 72. Further, a direction connecting the upper gap and the lower gap at the distal end of the tank tube 115 is parallel to a direction in which the right straight groove 171 and the left straight groove 172 extend.

In a state where the ink bottle 80 is connected to the ink tank 100, ink stored in the ink bottle 80 flows into the corresponding ink chamber 111 through the inner space of the bottle tube 96. Simultaneously, air flows into the ink chamber 111 from the air communication port 112, and then air flows into the inside of the ink bottle 80 through the corresponding tank tube 115. As described above, so-called gas–liquid replacement occurs, and accordingly ink inside the ink bottle 80 is supplied to the corresponding ink chamber 111. The supply of ink automatically stops when the ink level inside the ink chamber 111 rises to the position of the upper line 181A.

### Technical Effects of This Embodiment

Since the center axis B3 of the valve 161 in the up-down direction is offset frontward relative to the center axis B2 of the opening portion 87, the valve 161 in the open position and the support member 84 can define the air flow passage 233, which is large and is located rearward of the valve 161 in the open position without increasing the size of the ink bottle 80. Accordingly, air which has flowed into the valve accommodating space 148 through the opening 95 is likely to move inside the air flow passage 233, and therefore gas-liquid exchange between the inside of the ink bottle 80 and the inside of the ink tank 100 can be smoothly performed. As a result, ink can be supplied quickly from the ink bottle 80 to the ink tank 100. Also, the left protruding portion 45A and the right protruding portion 46B contact the valve 161 toward the front. As a result, the likelihood that the valve 161 is displaced rearward when the valve 161 moves from the open position to the closed position can be reduced, regardless of the air flow passage 233, which is large and is located rearward of the valve 161, being located.

The center axis B1 of the protrusion 94 is offset frontward relative to the center axis B2 of the opening portion 87. The center axis B3 of the valve 161 is slightly offset frontward relative to the center axis B1 of the protrusion 94. Accordingly, since the center axis B3 of the valve 161 is significantly offset frontward relative to the center axis B2 of the opening portion 87, the valve 161 in the open position and the support member 84 can define the air flow passage 233, which is large and is located rearward of the valve 161 in the open position. As a result, gas-liquid exchange between the inside of the ink bottle 80 and the inside of the ink tank 100 can be smoothly performed.

Since the valve 161 in the open position and the support member 84 define the left ink flow passages 415A and the right ink flow passages 415B at a position different from the air flow passage 233, a passage in which air moves and a passage in which ink moves can be easily separated. As a result, gas-liquid exchange between the inside of the ink bottle 80 and the inside of the ink tank 100 can be smoothly performed.

Since the area S3 of the air flow passage 233 is larger than the area S4 of the ink flow passage 415, air can easily move inside the air flow passage 233. As a result, gas-liquid exchange between the inside of the ink bottle 80 and the inside of the ink tank 100 can be smoothly performed.

Each of the four left protruding portions 45A, 45B, 45C, and 45D contacts the left outer flat surface 162C of the flat surface portion 162. Each of the four right protruding portions 46A, 46B, 46C, and 46D contacts the right outer flat surface 162D of the flat surface portion 162. As a result, even when the left ink flow passages 415A is positioned leftward of the valve 161 in the left-right direction and the right ink flow passages 415B is positioned rightward of the valve 161 in the left-right direction, the likelihood that the valve 161 is displaced in the left-right direction and rotates when the valve 161 moves from the open position to the closed position can be reduced.

Since the left ink flow passages 415A is positioned leftward of the valve 161 in the left-right direction and the right ink flow passages 415B is positioned rightward of the valve 161 in the left-right direction, ink stored inside the ink storage chamber 147 can easily move to the opening 97A through the left ink flow passages 415A and the right ink flow passages 415B.

The key member 99, configured to be inserted in the corresponding key groove 74 of the tank cover 110, is not rotationally symmetrical about the center C1 of the protrusion 94. As a result, upon supplying ink stored inside the ink storage chamber 147 to the ink tank 100, a user can insert the protrusion 94 of the ink bottle 80 in a correct orientation into the corresponding through-hole 72 of the tank cover 110.

Since the protrusion 163 protrudes upward toward the opening 95 and the opening 96A from the portion inward of the outer peripheral surface of the flat surface portion 162, the air flow passage 233, defined by the valve 161 at the open position and the support member 84, is larger at the position of the protrusion 163 than the air flow passage 233 at the position of the flat surface portion 162. As a result, air which has flowed into the valve accommodating space 148 through the opening 95 easily moves in the air flow passage 233

The rubber 83, positioned at the opening 97A of the protrusion 94, has the opening 95, through which air moves, and the opening 96A, through which ink moves. Accordingly, the passage in which air moves and the passage in which ink moves can be separated. As a result, gas-liquid exchange between the inside of the ink bottle 80 and the inside of the ink tank 100 can be smoothly performed.

Each tank tube 115 extends upward and extends outward of the ink tank 100 in the extending direction, which crosses both the direction of gravity and the horizontal direction. As a result, a user can easily insert the tank tube 115 into the opening 95 of the corresponding ink bottle 80.

In a state where the tank tube 115 is inserted into the corresponding opening 95, the air flow passage 233 is located above both the left ink flow passages 415A and the right ink flow passages 415B. Accordingly, when air, which is lighter than ink, flows into the valve accommodating space 148 through the tank tube 115, the air is likely to move to the ink storage chamber 147 through the air flow passage 233. On the other hand, ink, which is heavier than air, is likely to move from the ink storage chamber 147 to the opening 96A through the left ink flow passages 415A and the right ink flow passages 415B. Since the passage in which air moves and the passage in which ink moves can be clearly separated, gas-liquid exchange between the inside of the ink bottle 80 and the inside of the ink tank 100 can be smoothly performed.

Air inside the ink tank 100 flows into the valve accommodating space 148 through the tank tube 115. On the other hand, ink inside the ink storage chamber 147 flows into the corresponding one of the four ink chambers 111 through the bottle tube 96. Since the passage in which air moves and the passage in which ink moves between the inside of the ink bottle 80 and the inside of the ink tank 100 are clearly separated, gas-liquid exchange can be smoothly performed.

In the up-down direction, the position of the distal end of the bottle tube 96 inserted in the communication port 119 coincides with the position of the upper line 181A. Accordingly, in each ink chamber 111, when the ink level rises at the position of the upper line 181A, the supply of ink stops automatically. As a result, in each ink chamber 111, the likelihood that ink stored inside the ink chamber 111 overflows to the outside through the corresponding communication port 119 can be reduced.

In a state where the tank tube 115 is inserted in the corresponding opening 95, the base end portion 115A, at which the tank tube 115 begins to branch into two lip portions, coincides with the edge 108A of the lip 108 in the extending direction, in which the tank tube 115 extends. Hence, the length of each tank tube 115 is short. As a result, even when the flow resistance in each tank tube 115 is high, smooth gas-liquid exchange between the inside of the ink bottle 80 and the inside of the ink tank 100 can be easily ensured.

### Variations

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The bottle cap 82 is detachably attached to the opening portion 87. However, the bottle cap 82 may be attached to the opening portion 87 such that the bottle cap 82 is not detachable from the opening portion 87 (i.e., the bottle cap 82 may be fixed to the opening portion 87 such that the bottle cap 82 is not detachable from the opening portion 87). The bottle cap 82 has the protrusion 94, which is offset relative to the center axis B2 of the opening portion 87. However, the bottle cap 82 does not necessarily have a portion offset relative to the center axis B2 of the opening portion 87. The bottle cap 82 and the opening portion 87 of the main body container 81A may be integrally molded product. In this case, there is no distinction between the bottle cap 82 and the opening portion 87, and the portion defining the valve accommodating space 148, in which the valve 161 is accommodated, corresponds to the neck portion. Even in this configuration, in which there is no distinction between the bottle cap 82 and the opening portion 87, the bottle cap 82 and the opening portion 87 which are integrally molded may have the protrusion 94 or the bottle cap 82 and the opening portion 87 which are integrally molded do not necessarily have the protrusion 94. Regardless of the configuration of the neck portion, the center axis B3 of the valve 161 is offset relative to the center axis B2 of the neck portion, defining the valve accommodating space 148 accommodating the valve 161 positioned in the open position.

The center axis B3 of the valve 161 is offset frontward relative to the center axis B1 of the protrusion 94. However, the center axis B3 of the valve 161 may coincide with the center axis B1 of the protrusion 94.

The center axis B1 of the protrusion 94 is offset frontward relative to the center axis B2 of the opening portion 87. However, the center axis B1 of the protrusion 94 may coincide with the center axis B2 of the opening portion 87, as long as the center axis B3 of the valve 161 is offset frontward relative to the center axis B2 of the opening portion 87.

The left ink flow passages 415A is positioned leftward of the valve 161 in the left-right direction and the right ink flow passages 415B is positioned rightward of the valve 161 in the left-right direction. However, the left ink flow passages 415A and the right ink flow passages 415B may be omitted. In this case, ink stored in the ink storage chamber 147 may move to the opening 96A through the air flow passage 233.

The area S3 of the air flow passage 233 is larger than the area S4, which is the sum of the area of each left ink flow passage 415A and the area of each right ink flow passage 415B. However, the area S3 of the air flow passage 233 is smaller than or equal to the area S4.

The four left protruding portions 45A, 45B, 45C, and 45D are configured to contact the valve 161 toward the right. However, the four left protruding portions 45A, 45B, 45C, and 45D do not necessarily contact the valve 161 toward the right. The four right protruding portions 46A, 46B, 46C, and 46D are configured to contact the valve 161 toward the left. However, the four right protruding portions 46A, 46B, 46C, and 46D do not necessarily contact the valve 161 toward the left.

One or more of the three left protruding portions 45B, 45C, and 45D and the three right protruding portions 46B, 46C, and 46D may be omitted.

The key member 99 may be omitted.

The upper surface 162A of the flat surface portion 162 is positioned around the protruding portion 163. However, the outer peripheral surface of the flat surface portion 162 and the outer peripheral surface of the protruding portion 163 may be flush with each other. Also, the protruding portion 163 may be omitted.

The opening 96A may be omitted. In this case, the bottle tube 96 and the communication port 119 is omitted. In this case, it is preferable that the tank tube 115 inserted in the opening 95 defines the air flow passage and the ink flow passage.

The tank tubes 115 may be omitted. In this case, the opening 95 may be omitted. In this case, the valve 161 moves from the open position to the closed position by a user’s operation. It is preferable that the bottle tube 96 inserted in the communication port 119 defines the air flow passage and the ink flow passage.

In a state where the corresponding tank tube 115 is inserted in the opening 95, the air flow passage 233 is positioned above both the left ink flow passages 415A and the right ink flow passages 415B. However, in a state where the corresponding tank tube 115 is inserted in the opening 95, the air flow passage 233 may be at the same position as the positions of both the left ink flow passages 415A and the right ink flow passages 415B in the up-down direction. In this case, each tank tube 115 extends upward in the up-down direction. Each communication port 119 opens upward.

In the up-down direction, the distal end of the bottle tube 96 inserted in the corresponding communication port 119 coincides with the position of the upper line 181A. However, the distal end of the bottle tube 96 inserted in the corresponding communication port 119 may be positioned above the position of the upper line 181A. Also, the distal end of the bottle tube 96 inserted in the corresponding communication port 119 may be positioned below the position of the upper line 181A.

In a state where the corresponding tank tube 115 is inserted in the opening 95, the base end portion 115A, at which the tank tube 115 begins to branch into two lip portions, coincides with the edge 108A of the lip 108 in the extending direction, in which each tank tube 115 extends. However, in a state where the corresponding tank tube 115 is inserted in the opening 95, the base end portion 115A may be positioned closer to the ink storage chamber 147 than the edge 108A is to the ink storage chamber 147.

The opening 96A may be omitted. In this case, the bottle tube 96 is omitted. Each tank tube 115 may include the flow passage in which air flows and the flow passage in which ink flows. In this case, the communication ports 119 are omitted.

The bottle tube 96 is configured to be diagonally inserted into the corresponding communication port 119 in the extending direction. However, for example, the communication ports 119 may be provided on the upper wall 104, extending in the horizontal direction, and the ink bottle 80 may be inserted downward into the corresponding communication port 119 in the up-down direction. In this case, each tank tube 115 may extend upward.

The main body container 81A of the ink bottle 80 has a cylindrical shape. However, the main body container 81A of the ink bottle 80 may have a rectangular parallelepiped shape. Also, the main body container 81A of the ink bottle 80 may have a bag shape.

The bottle tube 96 may be omitted. In this case, the ink tank 100 includes an ink nozzle defining the ink flow passage, in which ink flows. The ink nozzle is configured to be inserted into the opening 96A.

What is claimed is:

1. A liquid container comprising:
a main body defining a first storage chamber configured to store liquid inside the first storage chamber, the main body having a neck portion defining an accommodation space;
a valve positioned inside the accommodation space, the valve being movable between a closed position and an open position;
a first port providing communication between an inside of the accommodation space and an outside of the accommodation space in a movement direction of the valve, the first port being closed when the valve is at the closed position, the first port being open when the valve is at the open position; and
a support member supporting the valve such that the valve is movable between the closed position and the open position, wherein a center axis of the valve extends in the movement direction,
wherein a center axis of the neck portion extends in the movement direction,
wherein the center axis of the valve is offset relative to the center axis of the neck portion in an offset direction orthogonal to the movement direction, wherein the valve at the open position and the support member define a fluid flow passage providing communication between the first port and the first storage chamber,
wherein the fluid flow passage is positioned further in an opposite direction relative to the center axis of the neck portion, the opposite direction being a direction opposite to the offset direction, and wherein the support member has a protruding portion in contact with the valve in the offset direction.

2. The liquid container according to claim 1,
wherein the neck portion has:
a first neck portion connected to the first storage chamber; and
a second neck portion in which the first port is located, wherein a center axis of the second neck portion extends in the movement direction,
wherein a center axis of the first neck portion extends in the movement direction,
wherein the center axis of the second neck portion is offset relative to the center axis of the first neck portion in the offset direction, and
wherein the center axis of the valve is offset relative to the center axis of the first neck portion in the offset direction.

3. The liquid container according to claim 2,
wherein the valve at the open position and the support member define a liquid flow passage in an orthogonal direction, the orthogonal direction being a direction orthogonal to both the offset direction and the movement direction.

4. The liquid container according to claim 3,
wherein an area of a cross-section of the fluid flow passage taken along a plane orthogonal to the movement direction is greater than an area of a cross-section of the liquid flow passage taken along the plane.

5. The liquid container according to claim 4,
wherein the protruding portion is in contact with the valve in both the offset direction and the orthogonal direction.

6. The liquid container according to claim 5,
wherein the liquid flow passage has:
a first liquid flow passage located on one side of the valve in the orthogonal direction; and
a second liquid flow passage located on an other side of the valve in the orthogonal direction, and
wherein the protruding portion has:
a first protruding portion located on the one side of the valve in the orthogonal direction, the first protruding portion having a first contact surface in contact with the valve in the offset direction and a second contact surface in contact with the valve toward the other side in the orthogonal direction; and
a second protruding portion located in the other side of the valve in the orthogonal direction, the second protruding portion having a third contact surface in contact with the valve in the offset direction and a fourth contact surface in contact with the valve toward the one side in the orthogonal direction.

7. The liquid container according to claim 6,
wherein the support member has:
a plurality of third protruding portions protruding from an inner surface of the support member, the plurality of third protruding portions being located further in the opposite direction relative to the first protruding portion, the first protruding portion and the plurality of the third protruding portions being arranged at intervals in the opposite direction; and
a plurality of fourth protruding portions protruding from the inner surface of the support member, the plurality of fourth protruding portions being located further in the opposite direction relative to the second protruding portion, the second protruding portion and the plurality of fourth protruding portions being arranged at intervals in the opposite direction,
wherein the plurality of the third protruding portions are in contact with the valve toward the other side in the orthogonal direction, and
wherein the plurality of the fourth protruding portions are in contact with the valve toward the one side in the orthogonal direction.

8. The liquid container according to claim 2,
wherein the neck portion is brought into connection with a connection port to supply the liquid stored in the first storage chamber to a tank,
wherein the neck portion has a key portion configured to be fitted in the connection port, and
wherein a shape of a cross-section of the key portion taken along a plane orthogonal to the movement direction is not rotationally symmetrical relative to the center axis of the second neck portion.

9. The liquid container according to claim 1,
wherein the valve includes:
a base portion having: an outer peripheral surface in contact with the protruding portion in an orthogonal direction, the orthogonal direction being a direction orthogonal to the movement direction; and
an inner portion positioned inward of the outer peripheral surface of the base portion; and
a stepped portion protruding toward the first port from the inner portion of the base portion, the stepped portion being configured to close the first port, and
wherein the stepped portion of the valve at the open position and an inner surface of the support member define the fluid flow passage.

10. The liquid container according to claim 1, further comprising:
a second opening providing communication between the inside of the accommodation space and the outside of the accommodation space in the movement direction, the second opening being closed when the valve is at the closed position, the second opening being open when the valve is at the open position.

11. A system comprising:
the liquid container according to claim 1;
a connection port to which the liquid container is connectable; and
a tank having a second storage chamber configured to store liquid supplied from the liquid container connected to the connection port.

12. The system according to claim 11,
wherein the tank includes a first nozzle providing communication between an inside of the second storage chamber and an outside of the second storage chamber, the first nozzle extending in a diagonally upward direction crossing a direction of gravity and a horizontal direction, the first nozzle extending further outward than the tank, the first nozzle being configured to be inserted into the first port, and
wherein insertion of the first nozzle into the first port causes the first nozzle to press and move the valve from the closed position to the open position.

13. The system according to claim 12,
wherein the valve at the open position and the support member define a liquid flow passage in an orthogonal direction, the orthogonal direction being a direction orthogonal to the offset direction and the movement direction, and
wherein, in a state where the first nozzle is inserted in the first port, the fluid flow passage is located above the liquid flow passage.

14. The system according to claim 11,
wherein the tank includes:
a first nozzle providing communication between an inside of the second storage chamber and an outside of the second storage chamber, the first nozzle extending further outward than the tank; and
an inlet providing communication between the inside of the second storage chamber and the outside of the second storage chamber,
wherein the neck portion has a second opening providing communication between the inside of the accommodation space and the outside of the accommodation space in the movement direction,
wherein the liquid container has a second nozzle extending further outward than the neck portion from the second opening in the movement direction,
wherein, in a state where the liquid container is connected to the connection port:
the first nozzle is inserted in the first port;
the second nozzle is connected to the inlet; and
the valve is maintained at the open position by being pressed by the first nozzle inserted in the first port.

15. The system according to claim 14,
wherein the tank has:
a front wall defining a front end of the second storage chamber; and
a mark disposed at an upper portion of the front wall, the mark indicating that a liquid level of liquid stored inside the second storage chamber is at a full level position, and
wherein a position of a distal end of the second nozzle connected to the inlet coincides with a position of the mark in an up-down direction.

16. The system according to claim 15, further comprising:
a rubber defining the first port,
wherein the rubber is positioned so as to surround a periphery of the first port, the rubber including a lip having an annular shape, the lip being in contact with the valve at the closed position,
wherein a distal end of the first nozzle is divided into two lip portions, and
wherein, in a state where the first nozzle is inserted in the first port, a base end portion of the two lip portions of the first nozzle coincides with a distal end of the lip in a direction in which the first nozzle extends.

17. A system comprising:
the liquid container according to claim 2;
a connection port to which the liquid container is connectable; and a tank having a second storage chamber configured to store liquid supplied from the liquid container connected to the connection port,
wherein the tank has an inlet providing communication between an inside of the second storage chamber and an outside of the second storage chamber, and
wherein the connection port is positioned so as to surround a periphery of the inlet, the second neck portion being connectable to the connection port.
